(19) United States
(12) Patent Application Publication
(10) Pub. No.: US 2024/0295146 A1
(43) Pub. Date: Sep. 5, 2024

(54) LADDER STABILIZING APPARATUS AND KIT

(71) Applicants: Jordan Spencer, St. John's (CA); Dale Edward Kean, St. John's (CA)

(72) Inventors: Jordan Spencer, St. John's (CA); Dale Edward Kean, St. John's (CA)

(21) Appl. No.: 18/572,889

(22) PCT Filed: Jul. 7, 2022
(86) PCT No.: PCT/CA2022/051066

§ 371 Date: Dec. 21, 2023

Related U.S. Application Data
(60) Provisional application No. 63/259,310, filed on Jul. 7, 2021.

(51) Int. Cl. E06C 7/46; E06C 7/44

(52) U.S. Cl. CPC E06C 7/46; E06C 7/44

(57) ABSTRACT

A ladder stabilizing apparatus includes a mount attachable to a ladder side rail, a retractable leg translatable relative to the mount between leg retracted and foot planted positions, a leg lock movable between leg locked and unlocked positions, a retractable ground anchor translatable between anchor retracted and ground embedded positions, an anchor lock movable between anchor locked and unlocked positions, and a pedal downwardly actuatable from a raised position to a depressed position. Downward actuation of the foot pedal comprises the leg translating relative to the mount towards the foot planted position, and the ground anchor translating relative to the leg towards the ground embedded position. In leg locked position, the leg lock inhibits translation of the leg relative to the mount towards the leg retracted position. In the anchor locked position, the anchor lock inhibits translation of the ground anchor relative to the leg toward the anchor retracted position.

### CROSS-REFERENCE TO RELATED APPLICATION

This application claims the benefit of U.S. Provisional Patent Application No. 63/259,310 filed Jul. 7, 2021, the entirety of which is incorporated herein by reference.

### FIELD

This disclosure relates generally to the field of ladder safety devices, and more specifically to ladder stabilizing apparatuses that are attachable to a ladder side rail.

### INTRODUCTION

A ladder can slip or topple during use due to inadequate engagement with the ground. When the ladder is supported on sloped ground and/or soft soil, the likelihood of slipping or toppling is increased. In turn, this increases the probability of an accident or serious injury to the user.

### SUMMARY

The following is intended to introduce the reader to the detailed description that follows and not to define or limit the claimed subject matter.

In accordance with a broad aspect, a ladder extension and spike device is disclosed. The ladder extension and spike device is easily attached to the bottom of a ladder to improve the safe use of that ladder. A push plate is provided on each ladder extension and spike device to deploy the ladder extension, the anchoring spike, or both. When pressure is applied to the push plate, the ladder extension is extended first until it firmly rests on the ground. Then the spike is deployed. These extensions are done in sequence. Both extensions are done incrementally and are accompanied by a ratchet noise providing an indication of displacement.

There is a market demand for a ladder extension to adjust at least one leg of the ladder so that both legs support the load equally. There is also a market need to secure both legs to the ground with a spike or other ground anchor. The present ladder extension and spike device provides both functions.

The present ladder extension and spike device is susceptible of a low cost of manufacture with regard to both materials and labour, and which accordingly is then susceptible of a low price of sale to the consumer, thereby making such ladder extension and spike device economically available to the public.

In accordance with another broad aspect, a ladder stabilizing apparatus is disclosed. The ladder stabilizing apparatus includes i) a rail mount attachable to a ladder side rail, ii) a retractable leg translatably coupled to the rail mount and translatable relative to the rail mount between a leg retracted position and a foot planted position, iii) a leg lock, iv) a retractable ground anchor translatably coupled to the retractable leg and translatable relative to the retractable leg between an anchor retracted position and a ground embedded position, v) an anchor lock, and vi) a foot pedal downwardly actuatable from a raised position to a depressed position. The retractable leg extends between a leg upper end and a leg lower foot. The leg lock is movable between a leg locked position, in which the leg lock inhibits a translation of the retractable leg relative to the rail mount towards the leg retracted position, and a leg unlocked position in which the translation of the retractable leg is uninhibited. The retractable ground anchor extends between an anchor upper end and a lower ground piercing end. The anchor lock is movable between an anchor locked position, in which the anchor lock inhibits a translation of the retractable ground anchor relative to the retractable leg toward the anchor retracted position, and an anchor unlocked position, in which the translation of the retractable ground anchor is uninhibited. Downward actuation of the foot pedal comprises the retractable leg translating relative to the rail mount towards the foot planted position, and the retractable ground anchor translating relative to the retractable leg towards the ground embedded position.

In accordance with another broad aspect, a ladder stabilizing apparatus is disclosed. The ladder stabilizing apparatus includes i) a rail mount having a quick release mechanism, and ii) a retractable leg. The quick release mechanism includes a) a ladder connector attachable to a ladder side rail, b) a leg connector rigidly attachable to the ladder connector, c) a connector lock movable between a connector locked position and a connector unlocked position, and d) a quick release actuator that when actuated moves the connector lock to the connector unlocked position. One of the ladder connector and the leg connector includes a male portion and the other of the ladder connector and the leg connector includes a female portion. The male portion is receivable by the female portion to rigidly attach the ladder connector and the leg connector. The connector lock is biased to the connector locked position. Attaching the ladder connector and the leg connector comprises the female portion receiving the male portion, and the connector lock moving to the connector locked position. When the male portion is received by the female portion, and the connector lock is in the connector locked position, the connector lock inhibits separation of the ladder connector and the leg connector. When the male portion is received by the female portion, and the connector lock is in the connector unlocked position, separation of the ladder connector and the leg connector is uninhibited. The retractable leg is translatably coupled to the leg connector and translatable relative to the leg connector between a leg retracted position and a foot planted position, the retractable leg extending between a leg upper end and a leg lower foot.

In accordance with another broad aspect, a kit is disclosed. The kit includes i) a ladder stabilizing apparatus, ii) a plurality of detachable feet. The ladder stabilizing apparatus includes a) a rail mount attachable to a ladder side rail, b) a retractable leg translatably coupled to the rail mount and translatable relative to the rail mount between a leg retracted position and a foot planted position, c) a leg lock, d) a retractable ground anchor translatably coupled to the retractable leg and translatable relative to the retractable leg between an anchor retracted position and a ground embedded position, e) an anchor lock, and f) a foot pedal downwardly actuatable from a raised position to a depressed position to translate at least one of the retractable leg and the retractable ground anchor. The retractable leg extends between a leg upper end and a leg lower end. The leg lock is movable between a leg locked position, in which the leg lock inhibits a translation of the retractable leg relative to the rail mount towards the leg retracted position, and a leg unlocked position in which the translation of the retractable leg is uninhibited. The retractable ground anchor extends between an anchor upper end and a lower ground piercing end. The anchor lock is movable between an anchor locked position, in which the anchor lock inhibits a translation of the retractable ground anchor relative to the retractable leg toward the anchor retracted position, and an anchor unlocked position, in which the translation of the retractable ground anchor is uninhibited. The plurality of detachable feet includes at least a first foot and a second foot. Each of the detachable feet are separately attachable to the leg lower end. The first foot includes an anchor opening. When the first foot is attached to the leg lower end, downward actuation of the foot pedal comprises the retractable leg translating relative to the rail mount towards the foot planted position, and the retractable ground anchor translating through the anchor opening towards the ground embedded position. When the second foot is attached to the leg lower end, downward actuation of the foot pedal comprises the retractable leg translating relative to the rail mount towards the foot planted position, and the second foot inhibiting translation of the retractable ground anchor towards the ground embedded position.

Other aspects and features of the teachings disclosed herein will become apparent to those ordinarily skilled in the art, upon review of the following description of the specific examples of the present disclosure.

### DRAWINGS

The drawings included herewith are for illustrating various examples of apparatuses and methods of the present disclosure and are not intended to limit the scope of what is taught in any way. In the drawings:

FIG. 1 is a perspective view of a ladder spike device according to a first embodiment;

FIG. 2 is a perspective view of a ladder extension and spike device according to a second embodiment;

FIG. 3 is an elevation view of a ladder with a pair of the ladder extension and spike devices of the second embodiment mounted thereto;

FIG. 4 is a combined cross-sectional and see-through view of the ladder extension and spike device of the second embodiment;

FIG. 5 is an enlarged cross-sectional and see-through view of the pawl arrangements in the ladder extension and spike device of the second embodiment;

FIG. 6 is a cross-sectional view through one pawl, showing a shoulder to prevent rotation thereof in a clockwise direction;

FIG. 7 is a bottom view one of the foot pads in the ladder extension and spike device of the second embodiment;

FIGS. 8A, 8B and 8C are front perspective, rear perspective and side views of a ladder stabilizing apparatus according to an embodiment, having a retractable leg shown in a leg retracted position and a retractable ground anchor shown in an anchor retracted position;

FIG. 8D is a cross-sectional view taken along line 8D-8D of FIG. 8A;

FIG. 8E is an enlarged view of the region shown in box 8E of FIG. 8D;

FIGS. 9A, 9B and 9C are front perspective, rear perspective, and side views of the ladder stabilizing apparatus of FIG. 8A, showing the retractable leg in a foot planted position and the retractable ground anchor in the anchor retracted position;

FIG. 9D is a cross-sectional view taken along line 9D-9D of FIG. 9A;

FIGS. 10A, 10B, 10C are front perspective, rear perspective and side views of the ladder stabilizing apparatus of FIG. 8A, showing the retractable leg in the foot planted position and the retractable ground anchor in a ground embedded position;

FIG. 10D is a cross-sectional view taken along line 10D-10D of FIG. 10A;

FIG. 10E is an enlarged view of the region shown in box 10E of FIG. 10D;

FIGS. 11A-11B are partial cross-sectional views of the ladder stabilizing apparatus of FIG. 8A, showing a leg lock in a leg locked position and a leg unlocked position, respectively;

FIGS. 12A and 12B are partial perspective views of the ladder stabilizing apparatus of FIG. 8A, showing a user-operated leg lock release actuator in a non-actuated position and an actuated position, respectively;

FIGS. 13A-13B are partial cross-sectional views of the ladder stabilizing apparatus of FIG. 8A, showing an anchor lock in an anchor locked position and an anchor unlocked position, respectively;

FIGS. 14A and 14B are partial cross-sectional views of the ladder stabilizing apparatus of FIG. 8A, showing a user-operated anchor lock release actuator in a non-actuated position and an actuated position, respectively;

FIGS. 15A and 15B are partial perspective views of the ladder stabilizing apparatus of FIG. 8A, showing ladder and leg connectors of a rail mount separated from each other;

FIG. 16A and 16B are partial perspective view of the ladder stabilizing apparatus of FIG. 8A, showing a connector lock of the rail mount in a locked position and an unlocked position, respectively;

FIGS. 17A and 17B are partial cross-sectional views of the ladder stabilizing apparatus of FIG. 8A, showing a quick release actuator in a non-actuated position and an actuated position, respectively;

FIG. 18 is a partial perspective view of the ladder stabilizing apparatus of FIG. 8A, showing a detachable foot separated from the retractable leg;

FIGS. 19A and 19B are top and bottom perspective views of a foot adapter that may be used with the ladder stabilizing apparatus of FIG. 8A;

FIG. 20 is a schematic illustration of an example kit for a ladder stabilizing apparatus that includes two detachable feet; and

FIG. 21 is a schematic illustration of an example ladder having a ladder stabilizing apparatus attached to one of its side rails.

Further aspects and features of the example embodiments described herein will appear from the following description taken together with the accompanying drawings.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)”, unless expressly specified otherwise.

The terms “including”, “comprising”, and variations thereof mean “including but not limited to”, unless expressly specified otherwise. A listing of items does not imply that any or all of the items are mutually exclusive, unless expressly specified otherwise. The terms “a”, “an”, and “the” mean “one or more”, unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

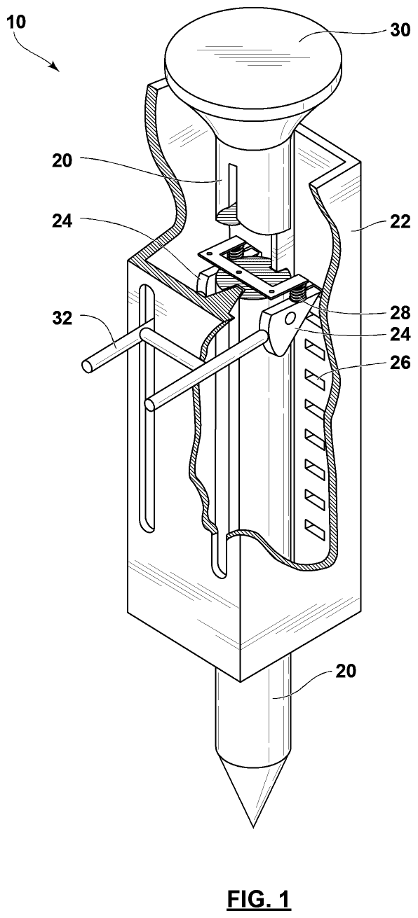

Referring to FIG. 1, the extensible ladder spike device 10 according to the first preferred embodiment is illustrated. A movable spike 20 is guided inside a tubular member 22. This tubular member 22 can be fastened to the leg of a ladder (not shown). A pair of pawls 24 are pivoted to the sides of the spike 20, one on each side of the spike 20, and are aligned for engagement with respective series of perforations 26 through the rear wall of the tubular member 22. The pawls 24 are urged for rotation in one direction by a respective spring 28. The pawls 24 are blocked in the other direction by design as one example will be provided later, so that a movement of the spike 20 in one direction will cause the pawls 24 to slide easily from one perforation 26 into another, but will prevent the reverse movement of the spike 20.

In use, the spike 20 is extended by pressing it downward by pressure of one's foot on the head 30 thereof, to anchor a leg of a ladder to the ground. A pair of levers 32 extends from the pawls 24 through the front wall of the tubular member 22. A downward movement of the levers 32 rotates the pawls 24, compresses the springs 28 and disengages the pawls 24 from the perforations 26, to allow the spike 20 to be drawn back into the tubular member 22. The levers 32 are joined together to operate the pawls 24 at the same time.

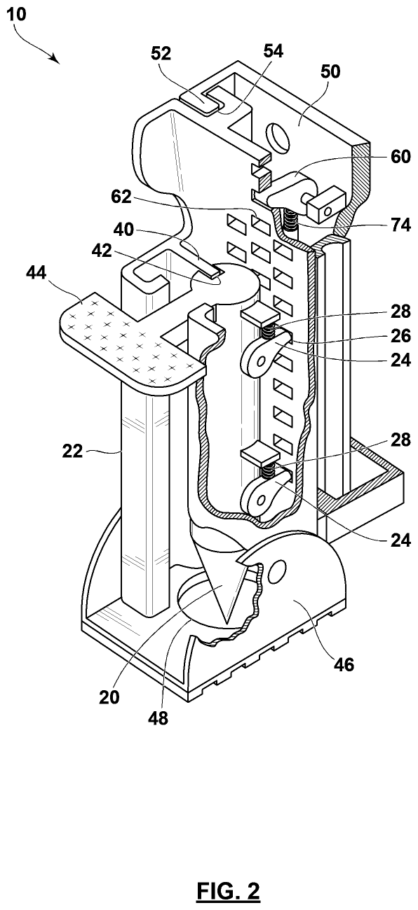

Referring to FIGS. 2-7, the ladder extension and spike device 10 according to the second preferred embodiment will be described. In this second embodiment, the spike 20 is enclosed in a tubular member 22 and guided by a flat projection 44 and a key-way 42. A push plate 44 extends laterally from the upper end of the spike 20 and is used to push the spike 20 downward out of the tubular member 22 and into the ground.

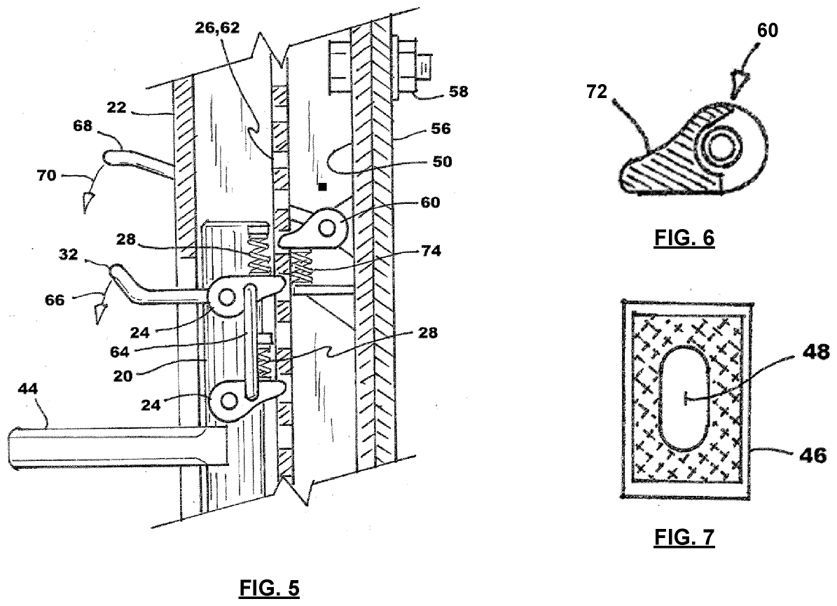

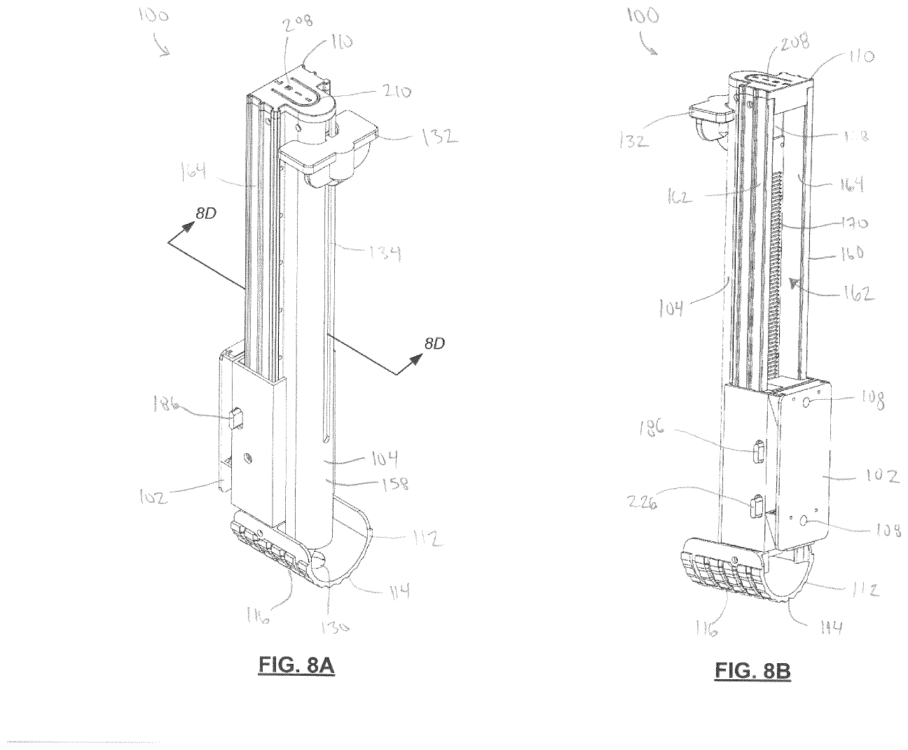

Similarly as the first preferred embodiment, the movement of the spike 20 is controlled by pawls 24 sliding into corresponding perforations 26. In the second preferred embodiment, the pawl arrangement on the spike 20 comprises four pawls 24, two on each side of the spike 20, of which only two can be seen in FIG. 2. One pair of pawls 24 is mounted to the spike 20 above the other, and with one pair linked to the other as illustrated in FIGS. 4 and 5. Two columns of perforations 26 are provided side-by-side in the rear wall of the tubular member 22 to register with the pawls 24 on each side of the spike 20.

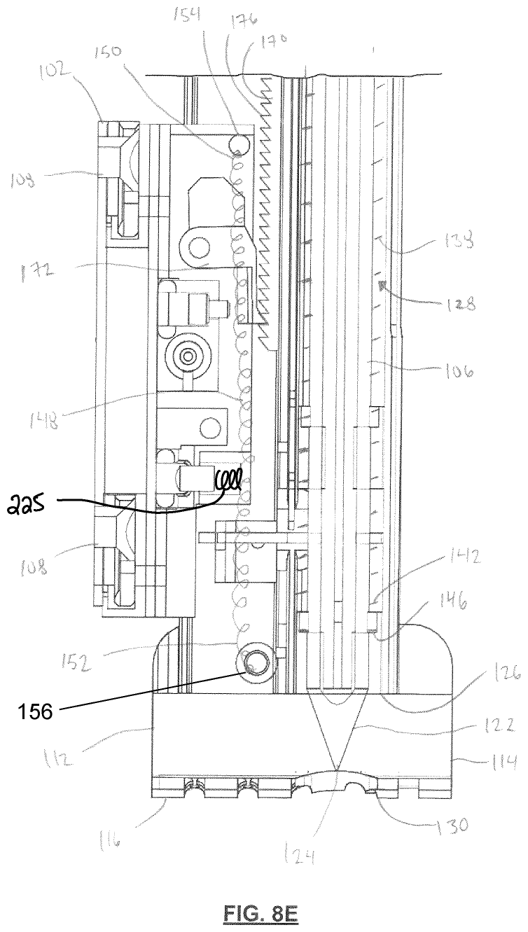

The tubular member 22 preferably has a modified ladder foot pad 46 mounted to the bottom thereof. This foot pad 46 has an oblong opening 48 therein to accommodate the extension of the spike 20 there through, with the foot pad 46 in different angular positions, as can be appreciated from the illustration in FIG. 7.

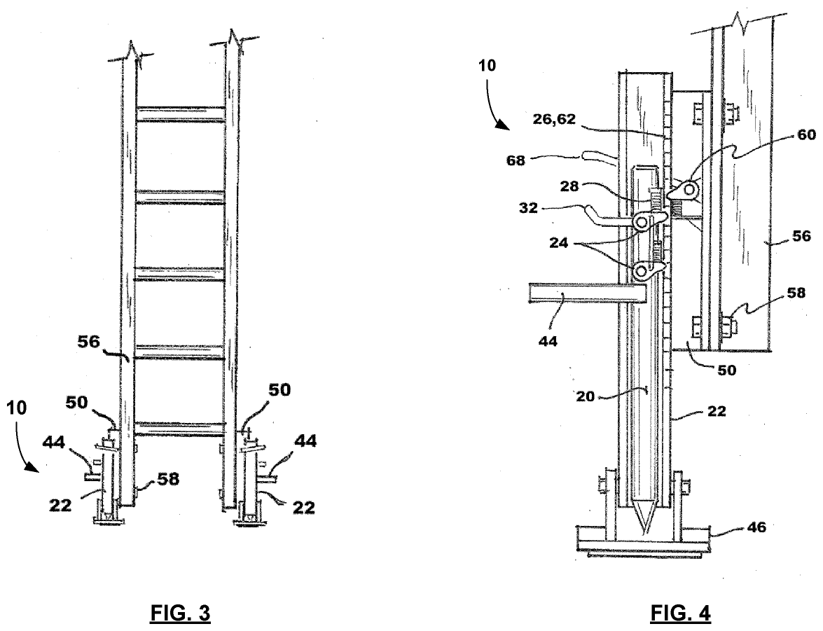

The tubular member 22 is movably mounted to a channel member 50, and it is retained to the channel member 50 by a lip 52 and groove 54 arrangement on each side of the channel member 50. This channel member 50 is attachable to the leg 56 of a ladder by bolts 58 for example, as illustrated in FIGS. 3 and 4.

The channel member 50 has a fifth pawl 60 mounted thereto for engagement with a third column of perforations 62 in the rear wall of the tubular member 22, between the two columns of perforations 26 mentioned before. The fifth pawl 60 controls the movement of the tubular member 22 relative to the channel member 50.

When the channel member 50 is attached to the leg 56 of a ladder, the movement of the tubular member 22 relative to the channel member 50 constitutes a ladder extension, and the movement of the spike 20 relative to the tubular member 22 constitutes a spike extension, as may be appreciated from FIGS. 3 and 4.

Referring now to FIG. 5, the pawl arrangement will be described. As mentioned, the two pairs of pawls 24 mounted to the spike 20 are connected together by a link member 64 so that they operate in unison. A single pair of levers 32 is connected to one pair of pawls 24. This pair of levers 32 moves in the direction 66 to release all four pawls 24 from their engagement into corresponding perforations 26, and for pulling the spike 20 back into the tubular member 22.

The fifth pawl 60 has a handle 68 which extends sideways from its axis, for example, and around the channel member 50 to the front of the tubular member 22. The handle 68 can be manipulated in the direction of arrow 70 to release the fifth pawl 60 from its corresponding perforation 62. Moving the handle 68 in the direction 70 allows the retraction of the tubular member 22 along the channel member 50. In other words, moving the handle in the direction 70 allows the retraction of the ladder extension.

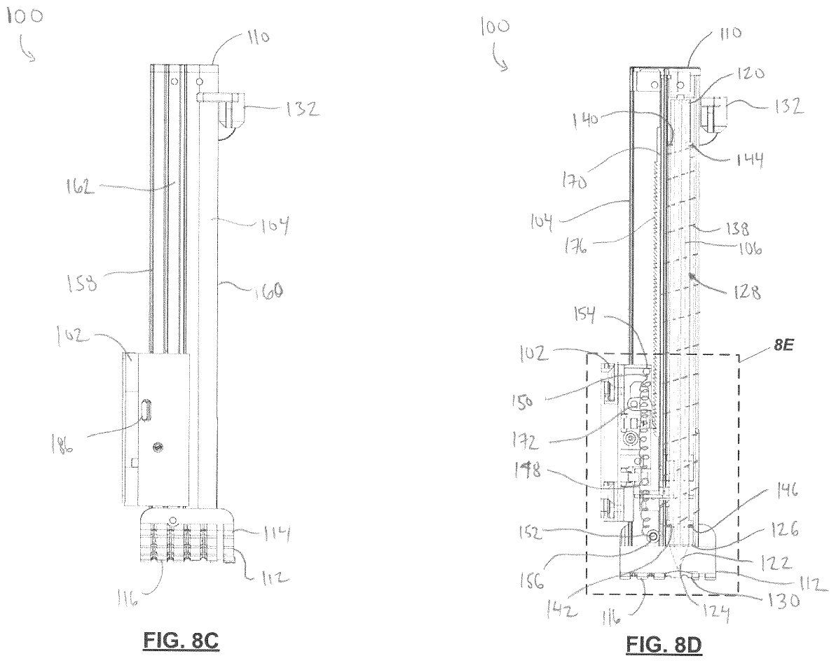

It will be appreciated that pawls 24 have a blocked rotation in the clockwise direction relative to their axes, so as to hold the spike 20 in the selected position. Pawl 60 has a blocked rotation in the counterclockwise direction relative to its axis. Such blocked rotation may be accomplished by a shoulder 72 in the configuration of the pawl 60, for example, as shown in FIG. 6. Pawl 60 also has a spring 74 acting thereon in a same way as springs 28 of pawls 24.

The function of the spring 74 acting on pawl 60 and the springs 28 acting on the four pawls 24 is to cause a resistance to movement on each pawl when sliding from one perforation to the next. The function of these springs is also to cause an incremental movement of the ladder extension and the anchoring spike and to create a ratchet noise thereby providing an audible indication of displacement when extending the ladder extension or the anchoring spike.

The spring 74 acting on pawl 60 and the springs 28 acting on the four pawls 24 have the same physical dimensions, spring rate and other properties. The leverage on all pawls 24,60 is the same. For these reasons, when a downward force is applied on the push plate 44, the tubular member 22, and thus the ladder extension will move down first, for its movement is restricted by only one spring 74. When the foot pad 46 on the ladder extension touches the ground, with the downward force on the push plate 44 still applied, the resistance of the four springs 28 is overcome, thereby allowing the downward movement of the anchoring spike 20 relative to the tubular member 22 for pushing the spike 20 into the ground for anchoring the ladder. The different spring resistance between the ladder extension and the anchoring spike causes the ladder extension and spike to be deployed one after the other in sequence.

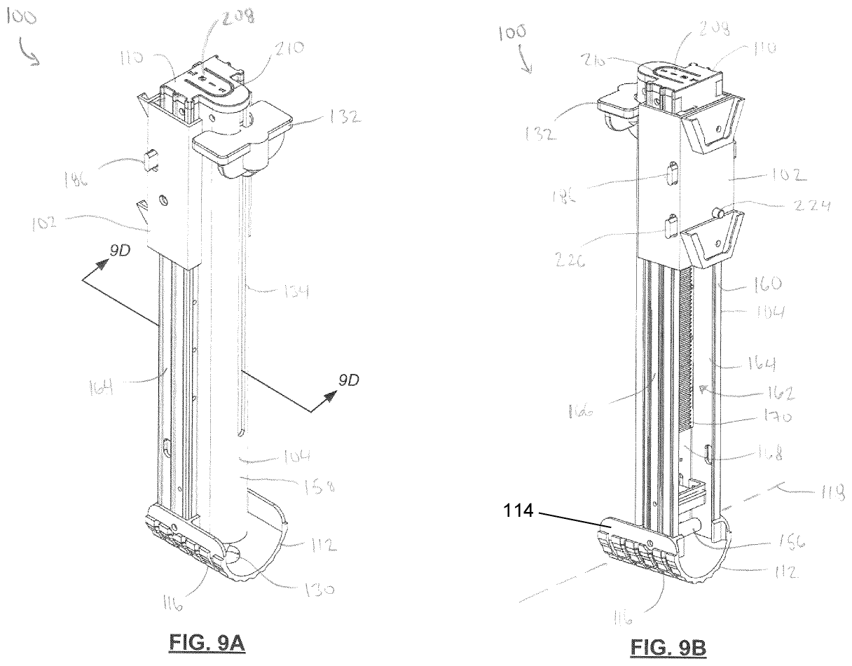

Reference is now made to FIGS. 8A-10E, which illustrate a ladder stabilizing apparatus 100 according to an embodiment. As shown, the ladder stabilizing apparatus 100 includes a rail mount 102 attachable to a side rail of a ladder, a retractable leg 104 translatably coupled to the rail mount 102, and a retractable ground anchor 106 translatably coupled to the retractable leg 104. In some cases, one ladder stabilizing apparatus 100 is attached to a ladder. In other cases, multiple ladder stabilizing apparatus 100 are attached to a ladder (i.e., one on each ladder side rail). In use, the retractable leg 104 is deployed to balance the ladder on uneven ground. Alternatively, or in addition, the retractable ground anchor 104 is deployed to embed the ground anchor 106 in the ground, and thereby anchor the ladder to the ground. In alternative embodiments, the apparatus 100 may include only one of retractable leg 104 and retractable ground anchor 106. For example, apparatus 100 may include retractable leg 104 but no ground anchor 106, or may include a retractable ground anchor 106 and a non-retractable leg 104.

The rail mount 102 is attachable to a side rail of a ladder (e.g., see ladder side rail 56 in FIG. 3) to secure the ladder stabilizing apparatus 100 to the ladder. The rail mount 102 may be attached to the ladder side rail in any manner that provides a rigid connection between the rail mount 102 and the ladder side rail. For example, the rail mount 102 may be configured as a clamp having a pair of spaced apart fingers that are tightenable against opposite sides of the ladder side rail. In the illustrated embodiment, the rail mount 102 includes a pair of mounting apertures 108 through which fasteners (e.g., screws, bolts, etc.) may pass to attach the rail mount 102 to the ladder side rail. In some embodiments, the rail mount 102 may be integrated into the ladder side rail (e.g., permanently attached to or integrally formed with the ladder side rail).

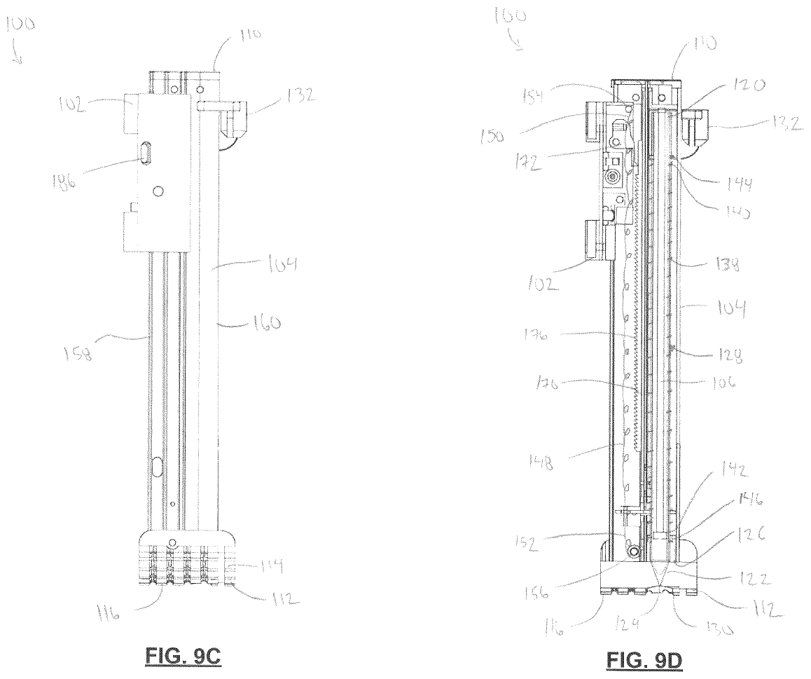

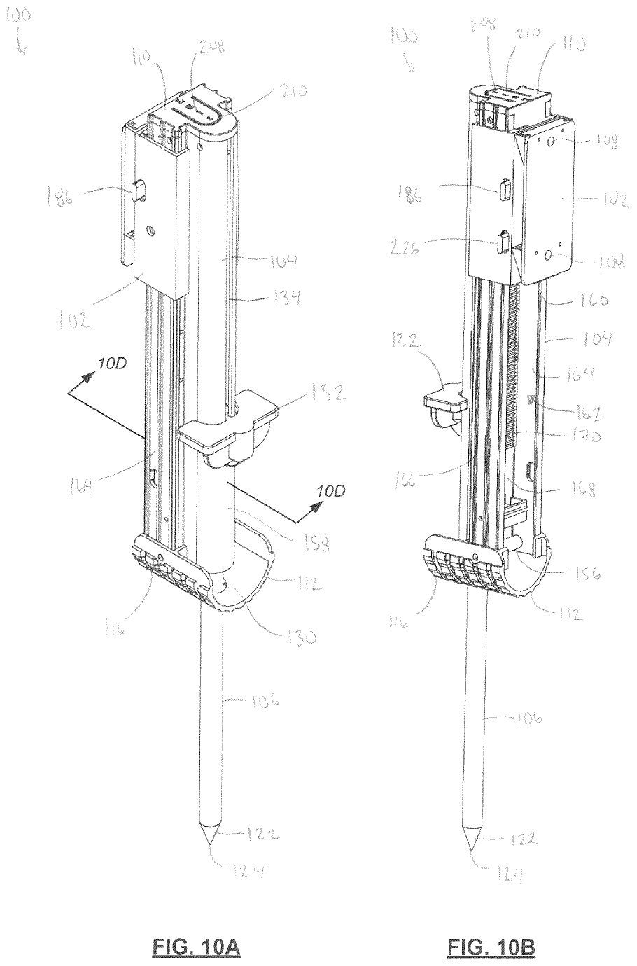

The retractable leg 104 (also referred to herein as a tubular member) extends between a leg upper end 110 and a leg lower end 112. The retractable leg 104 is translatable relative to the rail mount 102 between a leg retracted position and a foot planted position. FIGS. 8A-8D show the retractable leg 104 in the leg retracted position. FIGS. 9A-9D and FIGS. 10A-10D show the retractable leg 104 in the foot planted position. The retractable leg 104 may be translated relative to the rail mount 102 toward the foot planted position until the leg lower end 112 contacts the ground.

With reference to FIGS. 8A and 8B, the retractable leg 104 has a front side 158 and a rear rail mounting side 160 opposite the front side 158. Each of the front and rear sides 158, 160 extend between the leg upper end 110 and the leg lower end 112. As shown on FIG. 8B, the rear rail mounting side 160 includes a channel 162 that extends toward the front side 158. The channel 162 is bounded at least in part by a pair of channel sidewalls 164, 166 and a channel end wall 168 extending between the recess sidewalls 164, 166. The rail mount 102 is partially received within the channel 162 and translatably coupled to one or more of the channel sidewalls 164, 166 and channel end wall 168. As will be described in more detail below, the channel end wall 168 includes a ratchet rack 170 and the rail mount 102 includes a pivotable pawl 172. The channel end wall 168 of the retractable leg 104 is translatably coupled to the rail mount 102 through mated engagement of the ratchet rack 170 and the pawl 172 (e.g., see FIG. 8E).

The retractable leg 104 need not be translated all the way to the foot planted position of FIGS. 9A-9D and FIGS. 10A-10D. Contact between the lower leg end 112 and the ground may occur at any point between, and including, the leg retracted and foot planted positions. The extent to which the retractable leg 104 is translated toward the foot planted position depends at least in part on the slope of the ground between ladder siderails.

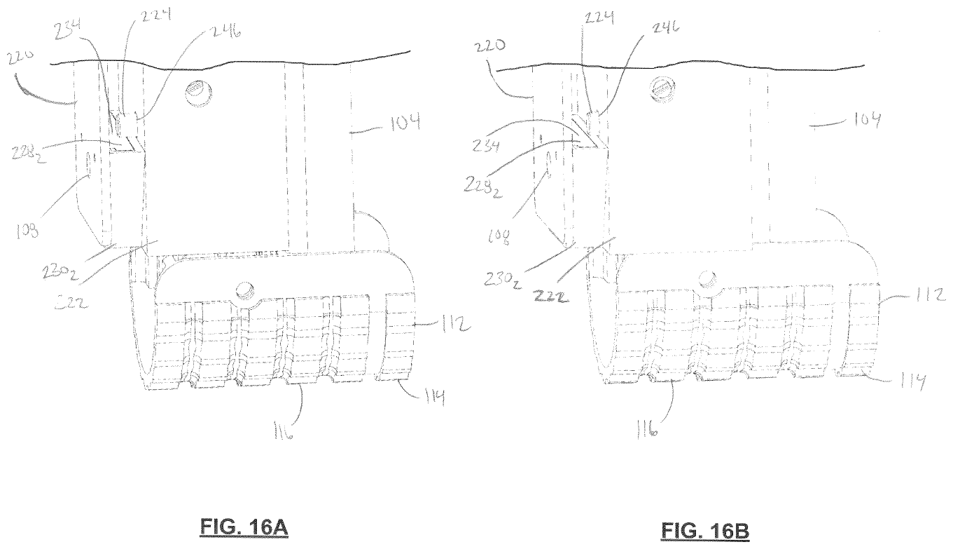

In the illustrated embodiment, the leg lower end 112 includes a detachable foot 114. As shown, the detachable foot 114 has a rounded ground engagement surface 116. The rounded ground engagement surface 116 may accommodate for unevenness in the landing area of the leg lower end 112. Turning to FIG. 18 shows the detachable foot 114 separated from the retractable leg 104. In some embodiments, the foot 114 may not be detachable from the leg lower end 112. In some embodiments, the leg lower end 112 may not include the detachable foot 114. In these embodiments, the leg lower end 112 may be configured to include the rounded ground engagement surface 116. In some embodiments, the leg lower end 112 may not have a rounded ground engagement surface 116.

As shown on FIGS. 9A-9B, the foot 114 extends outboard of the leg lower end 112. By extending outboard of the leg lower end 112, the foot 114 can increase the amount of surface-to-surface engagement with the ground in comparison to embodiments in which the foot 114 does not extend outboard of the leg lower end 112 and/or embodiments in which the lower leg end 112 does not include a foot 114. The increased amount of surface-to-surface contact may provide a sturdier engagement between the retractable leg 104 and the ground. In alternative embodiments, the foot 114 may not extend outboard of leg lower end 112.

As shown on FIG. 9B, the foot 114 is pivotable about a foot pivot axis 118 relative to retractable leg 104. By pivoting about the foot pivot axis 118, the foot 114 may be able to accommodate for unevenness in the landing area of the leg lower end 112. In some embodiments, the foot 114 may not be pivotable.

The retractable ground anchor 106 (also referred to herein as a movable spike) extends between an anchor upper end 120 and a lower ground piercing end 122. The retractable ground anchor 106 is translatable between an anchor retracted position and a ground embedded position. FIGS. 8D and FIGS. 9D show the retractable ground anchor 106 in the anchor retracted position. FIGS. 10A-10D show the retractable ground anchor 106 in the ground embedded position. The retractable ground anchor 106 may be translated relative to the retractable leg 104 toward the ground embedded position until the lower ground piecing end 122 is embedded in the ground.

In the illustrated embodiment, the lower ground piercing end 122 of the retractable ground anchor 106 includes a pointed tip 124. The pointed tip 124 may make it easier for the lower ground piercing end 122 to penetrate the ground. In some embodiments, the lower ground piercing end 122 may not include a pointed tip 124. In these embodiments, the retractable ground anchor 106 may take the form of a shaft with a consistent cross-section from the anchor upper end 120 to the lower ground piercing end 122.

The retractable ground anchor 106 need not be translated all the way to the ground embedded position of FIGS. 10A-10D. For example, translation of the retractable ground anchor 106 toward the ground embedded position may be stopped when the retractable ground anchor 106 is believed to have been embedded deep enough to inhibit slippage between the leg lower end 112 of the retractable leg 104 and the ground (or when the ground anchor 106 encounters a rock or other impenetrable material). The extent to which the retractable ground anchor 106 is translated toward the ground embedded position depends at least in part on the hardness/softness of the ground. A user may choose to embed retractable ground anchor 106 deeper into soft ground than hard ground to provide equivalent anchoring.

The lower ground piercing end 122 is preferably level with or retracted above the leg lower foot 112 when the retractable ground anchor 106 is in the anchor retracted position. Owing to this arrangement, the lower ground piercing end 122 of the retractable ground anchor 106 does not extend past the leg lower foot 112 of the retractable leg 104 unless the retractable ground anchor 106 is at least partly translated toward the ground embedded position. As best shown on FIGS. 8D and 9D, the lower ground piercing end 122 is about level the leg lower foot 112 (or slightly retracted) when the retractable ground anchor 106 is in the anchor retracted position. In some embodiments, the lower ground piercing end 122 may extend past the leg lower foot 112 when the retractable ground anchor 106 is in the anchor retracted position.

As shown on FIGS. 8D and 8E, the retractable leg 104 includes an anchor opening 126 and an internal passage 128 extending upwardly from the anchor opening 126. The retractable ground anchor 106 is translatable within the internal passage 128 of the retractable leg 104 between the anchor retracted position and the ground embedded position. Such an arrangement may enhance durability of the ladder stabilizing apparatus 100 as the ground anchor 106 is protected within the retractable leg 104 when not in use. Alternatively, or in addition, this arrangement may be visually appealing as the retractable ground anchor 106 is at least partially hidden within the retractable leg 104 when not in use. In some embodiments, the retractable leg 106 may not include the anchor opening 126 and the internal passage 128. In these embodiments, the retractable ground anchor 106 may be translatably coupled to the retractable leg 104 externally of the retractable leg 104.

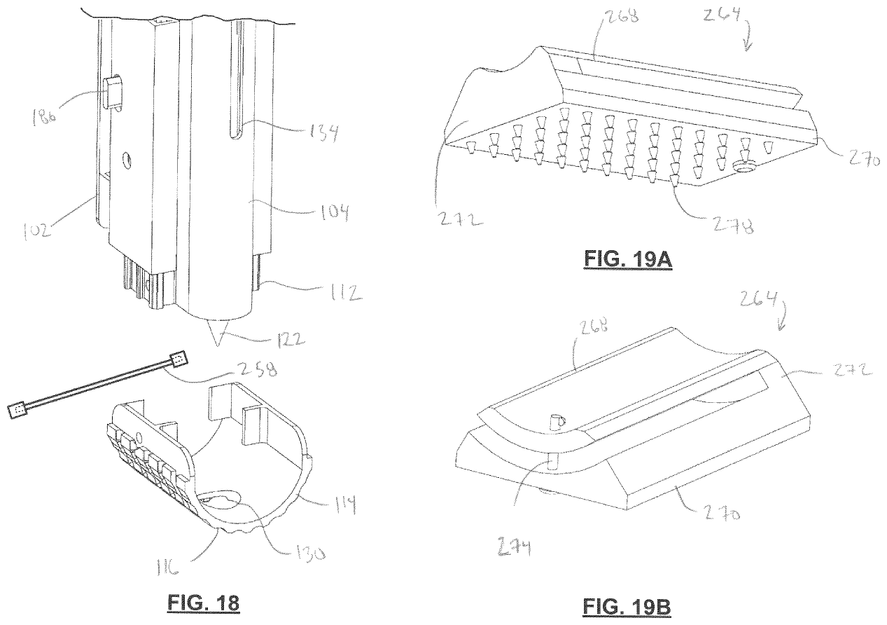

Referring to FIG. 10A, 10D, and 10E, the foot 114 includes an anchor opening 130. When the foot 114 is attached to the leg lower end 112, the anchor opening 130 of the foot 114 aligns with the anchor opening 126 of the retractable leg 104. As shown on FIG. 10E, the retractable ground anchor 106 can pass through the aligned anchor openings 126, 130 without obstruction. In some embodiments, the foot 114 may not include an anchor opening 130 (e.g., see foot 1143 on FIG. 20). In these embodiments, the retractable ground anchor 106 may translate adjacent to the foot 114 (e.g., the foot 114 may be laterally offset from the ground anchor 106 so that the ground anchor 106 does not pass through the foot 114 when translated). For clarity of illustration, the pawl 172 is omitted from FIG. 10D.

The ladder stabilizing apparatus 100 includes a foot pedal 132 (also referred to herein as a push plate) that is downwardly actuatable from a raised position to a depressed position. FIGS. 8A-8D show the foot pedal 134 in the raised position. FIGS. 10A-10D show the foot pedal 134 in the depressed position. An operator may actuate the foot pedal 132 (e.g., by putting one of their feet on the pedal 132 and moving that foot toward the ground). As will be discussed below, downward actuation of the foot pedal 132 translates at least one of (a) the retractable leg 104 toward the foot planted position and (b) the retractable ground anchor 106 toward the ground embedded position. In some embodiments, the ladder stabilizing apparatus 100 may not include the foot pedal 132. In these embodiments, the retractable leg 104 and/or the retractable ground anchor 106 may be translated in another suitable way. For example, a downwardly actuable plunger for hand actuation may extend upwardly of the anchor upper end 120.

With reference to FIGS. 8A and 8D, the foot pedal 132 is rigidly coupled to the retractable ground anchor 106. Accordingly, as the foot pedal 132 is actuated (i.e., moved) relative to the retractable leg 104 toward the depressed position, the retractable ground anchor 106 translates toward the ground embedded position. When the foot pedal 132 is in the raised position (e.g., FIG. 8A), the ground anchor 106 is in the anchor retracted position. Conversely, when the foot pedal 132 is in the fully depressed position (e.g., FIG. 10A), the ground anchor 106 is in the ground embedded position. In the pedal depressed position (e.g., FIG. 10A), the foot pedal 134 has moved away (e.g., maximally away) from the pedal raised position (e.g., FIG. 8A) relative to the rail mount 102 and relative to the retractable leg 104. As described below, between the pedal raised and pedal depressed positions, there may be intermediate positions where (a) retractable leg 104 has moved towards its foot planted position but the retractable ground anchor 106 remains at its anchor retracted position, and (b) the retractable leg 104 remains at its leg retracted position but the retractable ground anchor 106 has moved towards its ground embedded position.

As shown, the foot pedal 132 is affixed to the anchor upper end 120. Such an arrangement provides for the greatest vertical displacement for the retractable ground anchor 106 between the anchor retracted position and the ground embedded position. All else being equal, the farther the ground anchor 106 can travel between the anchor retracted position (FIGS. 8D and 9D) and the ground embedded position (FIG. 10D), the deeper it can be embedded in the ground. In some embodiments, the foot pedal 132 may be affixed elsewhere to the retractable ground anchor 106. Referring to FIG. 8A, the retractable leg 104 includes an elongate slot 134 through which the foot pedal 132 is affixed to the retractable ground anchor 106. In the illustrated embodiment, the slot 134 extends from the leg upper end 110 toward the leg lower end 112. The slot 134 is dimensioned to provide the foot pedal 132 with clearance to actuate between the raised position (FIG. 8A) and the depressed positions (FIG. 10A)

Downward actuation of the foot pedal 132 (i.e., towards the pedal depressed position) comprises one or both of (a) the retractable leg 104 translating relative to the rail mount 102 towards the foot planted position, and (b) the retractable ground anchor 106 translating relative to the retractable leg 104 towards the ground embedded position. As an example, a single downward actuation of the foot pedal 132 (one continuous movement) can translate the retractable leg 104 towards the foot planted position and the ground anchor 106 towards the ground embedded position. In effect, in one action, an operator can use the ladder stabilizing apparatus 100 to both i) balance the ladder with respect to the ground by translating the retractable leg 104 toward the ground and ii) anchor the ladder to the ground by embedding the ground anchor 106 into the ground.

The retractable ground anchor 106 is biased to the anchor retracted position. The retractable ground anchor 106 may be biased to the anchor retracted position in any suitable way (e.g., by a spring or elastic band). In the illustrated embodiment, the retractable ground anchor 106 is biased to the anchor retracted position by an anchor spring 138 contained within in the internal passage 128 of the retractable leg 104. As shown on FIG. 8D, the retractable ground anchor 106 extends through the anchor spring 138. In some embodiments, the retractable ground anchor 106 may not be biased to the anchor retracted position.

The anchor spring 138 resists translation of the retractable ground anchor 106 relative to the retractable leg 104 toward the ground embedded position. The anchor spring 138 has a spring upper end 140 and a lower spring end 142 opposite the spring upper end 140. The retractable ground anchor 106 includes a band 144 proximate the anchor upper end 120. The spring upper end 140 engages an underside surface of the band 144. The internal passage 128 of the retractable leg 104 includes a platform 146 proximate the anchor opening 126. The spring lower end 142 sits on the platform 146. The anchor spring 138 is sandwiched between the band 144 and the platform 146 on opposite ends. As the ground anchor 106 translates relative to the retractable leg 104 toward the ground embedded position, the anchor spring 138 is compressed (relative to its natural state) between the band 144 and the platform 146 (e.g., see FIG. 10E). Accordingly, the anchor spring 138 is either in a neutral state (i.e., no compression or extension) or is still compressed (i.e., still urging to extend) when retractable ground anchor 106 is in the anchor retracted position. The anchor spring 138 urges translation of the retractable ground anchor 106 back to the anchor retracted position (e.g., see FIG. 8D) upon the release of the compression developed in the anchor spring 138.

The retractable leg 104 is biased to the leg retracted position. The retractable leg 104 may be biased to the leg retracted position in any suitable way (e.g., by a spring or elastic band). In the illustrated embodiment, the retractable leg 104 is biased to the leg retracted position by a leg spring 148. In some embodiments, the retractable leg 104 may not be biased to the leg retracted position.

The leg spring 148 resists translation of the retractable leg 104 relative to the rail mount 102 toward the leg planted position. The leg spring 148 has a spring upper end 150 and a lower spring end 152 opposite the spring upper end 150. As shown on FIG. 8E, the spring upper end 150 is coupled to a spring aperture 154 formed in the rail mount 102 and the spring lower end 152 is coupled to a connector rod 156 provided at the leg lower end 112. The connector rod 156 is also illustrated in FIG. 9B. As the retractable leg 104 translates relative to the rail mount 102 toward the foot planted position, the leg spring 148 is stretched (relative to its natural state) between the spring aperture 154 and the connector rod 156 (e.g., see FIG. 9D). Accordingly, leg spring 148 is either in its natural state (i.e., no compression or extension) or is still stretched (i.e., extended) when the retractable leg 104 is in the leg retracted position. The leg spring 148 urges the retractable leg 104 back to the leg retracted position (e.g., see FIG. 8D) upon release of the tension developed in the leg spring 148.

The anchor spring 138 resists translation of the ground anchor 106 relative to the retractable leg 104 toward the ground embedded position to a greater extent than the leg spring 148 resists translation of the retractable leg 104 relative to the rail mount 102 towards the foot planted position. For example, the anchor spring 138 may have a higher stiffness per unit distance than the leg spring 148. Since the leg spring 148 provides less resistance to the translation of the retractable leg 104 relative to the rail mount 102, downward actuation of the foot pedal 132 translates the retractable leg 104 relative to the rail mount 102 in preference to translating the retractable ground anchor 106 relative to the retractable leg 104. In other words, the different spring resistances cause the retractable leg 104 to be deployed before (or more quickly than) the retractable ground anchor 106.

The downward actuation of the foot pedal 132 may comprise a first movement stage in which the retractable leg 104 moves towards the foot planted position, and a second movement stage in which the retractable ground anchor 106 moves towards the ground embedded position and the retractable leg 104 is stationary. The first movement stage may end when the leg lower end 112 contacts the ground, at which time the second movement stage begins. In alternative embodiments, downward actuation of foot pedal 132 has only a single movement stage in which both the ground anchor 106 and retractable leg 104 move towards their extended positions in unison.

During the first movement stage, downward actuation of the foot pedal 132 moves the retractable leg 104 toward the foot planted position because the retractable leg 104 encounters less resistance to translation than translation of the retractable ground anchor 106 toward the ground embedded position. In effect, the retractable leg 104 and the ground anchor 106 translate according to a “path of least resistance”. As described above, the leg spring 148 provides less resistance to translation of the retractable leg 104 toward the foot planted position compared to the resistance the anchor spring 138 provides to resist translation of the retractable ground anchor 106 toward the ground embedded position. Accordingly, when a downward force is applied to the foot pedal 132, the retractable leg 104 translates toward the foot planted position before the ground anchor 106 begins to translate toward the ground embedded position (or to a much greater degree than the translation of the ground anchor 106 towards the ground embedded position). This is because the resistance applied by the leg spring 148 is easier to overcome than the anchor spring 138. In some embodiments, the first movement stage comprises retractable leg 104 moving relative to mount 102 by at least twice as much as the distance that ground anchor 106 moves relative to retractable leg 104.

When the leg lower end 112 contacts the ground, the first movement stage ends, and the second movement stage begins. At this point, it becomes easier for the downward actuation of the foot pedal 132 to translate the retractable ground anchor 106 towards the ground embedded position than to continue translating the retractable leg 104 toward the foot planted position. This is because further translation of the retractable leg 104 is now resisted by the ground. When the leg lower end 112 is in contact with the ground and the downward actuation still applied to the foot pedal 132, the resistance provided by the anchor spring 138 is overcome, thereby allowing translation of the retractable ground anchor 106 toward the ground embedded position.

FIGS. 8A-8E show the ladder stabilizing apparatus 100 prior to downward actuation of the foot pedal 132. The retractable leg 104 is shown in the leg retracted position and the retractable anchor 106 is shown in the anchor retracted position. The ladder stabilizing apparatus may be kept in this configuration when not in use and/or when the ladder is put away.

FIGS. 9A-9D show the ladder stabilizing apparatus 100 between the first and second movement stages. The retractable leg 104 is shown in the foot planted position and the retractable anchor 106 is shown in the anchor retracted position. Comparing FIGS. 9A-9D to FIGS. 8A-8D, shows that the retractable leg 104 has translated downwardly with respect to the rail mount 102. In this position, the leg lower end 112 can engage the ground in effort to balance the ladder with respect to the ground. Comparing FIGS. 9A-9D to FIGS. 8A-8D also shows that the retractable ground anchor 106 has translated downwardly with respect to the rail mount 102 (i.e., because it moves with the retractable leg 104). However, the retractable ground anchor 106 has not yet translated relative to the retractable leg 104.

As shown on FIGS. 9A-9D, the foot pedal 132 remains in the same position relative to the retractable leg 104 even though it has been actuated downwardly throughout the first movement stage. As previously described, the foot pedal 132 is affixed to the retractable ground anchor 106 (i.e., they move as one). While the downward actuation in the first movement stage has not actuated the foot pedal 132 with respect to the retractable leg 104, it has translated the retractable leg 104 downwardly with respect to the rail mount 102.

As previously described, the retractable leg 104 need not be translated all the way to the foot planted position shown in FIGS. 9A-9D. Engagement between the lower leg end 112 and the ground may occur at any point between, and including, the leg retracted and foot planted positions. The extent to which the retractable leg 104 is translated toward the foot planted position depends at least in part on the slope of the ground between ladder siderails.

FIGS. 10A-10E show the ladder stabilizing apparatus 100 at the end of the second movement stage. The retractable leg 104 is shown in the foot planted position and the retractable ground anchor 106 is shown in the ground embedded position. When the leg lower end 112 is in contact with the ground, continued downward actuation of the foot pedal 132 overcomes the resistance provided by the anchor spring 138 and the retractable ground anchor 106 translates toward the ground embedded position. As shown, the retractable ground anchor 106 has translated downwardly with respect to the retractable leg 104. In this position, the retractable ground anchor 106 can be embedded into the ground, thereby anchoring the ladder to the ground. Comparing FIGS. 10A-10D to FIGS. 9A-9D, shows that the retractable leg 104 remains stationary throughout the second movement stage.

As previously described, the retractable ground anchor 106 need not be translated all the way to the ground embedded position of FIGS. 10A-10E. For example, translation of the retractable ground anchor 106 toward the ground embedded position may be stopped when the retractable ground anchor 106 is believed to have been embedded deep enough to inhibit slippage between the leg lower end 112 of the retractable leg 104 and the ground. Accordingly, the foot pedal 132 may not need to be actuated all the way to the depressed position of FIGS. 10A-10E. The extent to which the retractable ground anchor 106 is translated toward the ground embedded position depends at least in part on the hardness/softness of the ground. A user may choose to embed the retractable ground anchor 106 deeper into soft ground than hard ground to provide equivalent anchoring.

The ladder stabilizing apparatus 100 may include a leg lock that is movable between a leg locked position and a leg unlocked position. In the leg locked position, the leg lock inhibits translation of the retractable leg 104 relative to the rail mount 102 towards the leg retracted position. In the leg unlocked position, translation of the retractable leg 104 is uninhibited (or at least the leg lock is not inhibiting the translation). The leg lock does not inhibit translation of the retractable leg 104 relative to the rail mount 102 towards the foot planted position regardless of whether the leg lock is in the leg locked or unlocked position. Various configurations of the leg lock are possible. In some embodiments, the ladder stabilizing apparatus 100 may not include a leg lock.

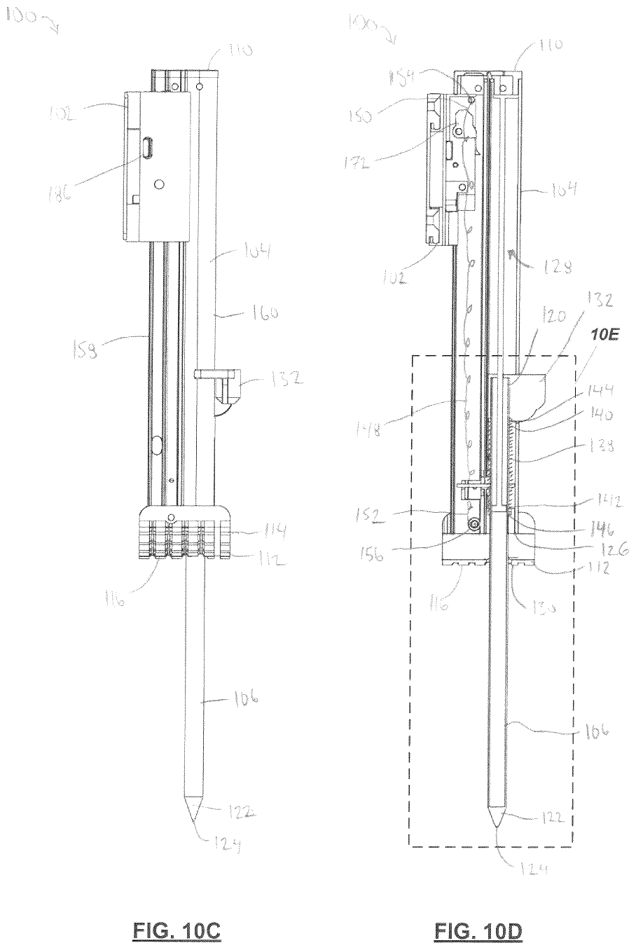

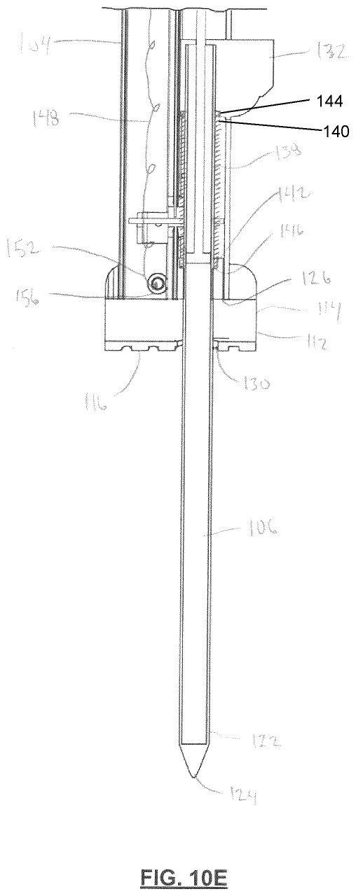

Reference is now made to FIGS. 11A-11B and FIGS. 12A-12B to demonstrate operation of the leg lock included in the illustrated embodiment. For clarity of illustration, a portion of the rail mount 102 is omitted from FIGS. 11A-11B and FIGS. 12A-12B. Referring to FIGS. 11A-11B, the leg lock includes a pawl 172 pivotably connected to the rail mount 102 at a pawl pivot axis 174. As shown, the pawl 172 is positioned opposite a ratchet rack 170 provided on the channel end wall 168. The ratchet rack 170 includes a plurality of pawl engagement teeth 176. The pawl 172 is pivotable about the pawl pivot axis 174 between a leg locked position (e.g., FIG. 11A) and a leg unlocked position (e.g., FIG. 11B). When in the leg locked position, the pawl 172 mates with a corresponding one of the pawl engagement teeth 176. In this position, the mated engagement between the ratchet rack 170 and the pawl 172 inhibits translation of the retractable leg 104 relative to the rail mount 102 towards the leg retracted position. Translation of the retractable leg 104 relative to the rail mount 102 towards the foot planted position is uninhibited by the pawl 172 in the leg locked position.

The leg lock may be biased to the leg locked position. The leg lock may be biased to the leg locked position in any suitable way. In the illustrated embodiment, the leg lock (e.g., pawl 172) is biased to the leg retracted position by a shaft 192. In some embodiments, the leg lock may not be biased to the leg locked position.

Shaft 192 is positioned to engage with a rear face of pawl 172 to continually urge pawl 172 into engagement with the ratchet rack 170 whereby the leg lock is held in the leg locked position. As shown, the shaft 192 may be spring-loaded to accommodate minor rotations of the pawl 172 as the pawl 172 translates across the teeth of rack 170.

In the illustrated embodiment, the ladder stabilizing apparatus 100 includes a user-operated leg lock release actuator 186. An operator can actuate (e.g., press) the leg lock release actuator 186 when they want to return the retractable leg 104 to the leg retracted position. As shown on FIG. 12A, opposite ends 188 and 190 of the user-operated leg lock release actuator 186 extend outwardly from rail mount 102. The user-operated lock release actuator 186 is actuated by pressing either one of the ends 188, 190 inwardly. The user-operated leg lock release actuator 186 may be biased to the non-actuated position (e.g., by springs 193 or other suitable means). The user-operated leg lock release actuator 186 includes a shaft 192. As shown on FIGS. 12A-12B, the shaft 192 of the user- operated leg release actuator 186 is slidable along a ramp 194 formed on a rear face of the pawl 172. The ramp 194 includes a crest 196 between a pair of declined surfaces 198, 200.

With reference to FIGS. 11A and 12A, the user-operated leg lock release actuator 186 is shown in a non-actuated position. In this position, the shaft 192 of the user-operated leg lock release actuator 186 abuts the crest 196 of the ramp 194, and the pawl 172 mates with a correspond one of the pawl engagement teeth 176 of the ratchet rack 170. In this position, the shaft 192 continually urges the pawl 172 into engagement with rachet rack 170, whereby the leg lock is held in the locked position.

With reference to FIGS. 11B and 12B, the user-operated leg lock release actuator 186 in shown an actuated position. In the example shown, the end 190 of the user-actuated leg lock release actuator 186 has been pushed (i.e., actuated) inwardly. Due to the actuation, the shaft 192 of the user-operated leg lock release actuator 186 now abuts the declined surface 198 of the ramp 194 (the shaft 192 has slid away from the crest 196). This provides clearance between the ramp 194 and the shaft 192 allowing pawl 172 to rotate about the pivot axis 174 out of engagement with ratchet rack 170. As shown, a pawl spring 178 may be positioned to urge pawl 172 to rotate about pivot axis 174 out of engagement with rack 172 when leg lock release actuator 186 is in the actuated position. Pawl spring 178 may have less stiffness than spring actuated shaft 192 whereby pawl spring 178 is unable to overcome shaft 192 when lock release actuator 186 is in the non-actuated position. As such, pawl spring 178 is only effective for moving pawl 172 out of engagement with rack 170 when user-operated leg lock release actuator 186 is in the actuated position.

The pawl spring 178 has a pawl spring first end 180 and a pawl spring second end 182 opposite the pawl spring first end 180. The pawl spring first end 180 is coupled to a rear surface 184 of the rail mount 102. The pawl spring second end 182 is coupled to the pawl 172 above the pawl pivot axis 174.

Moving the pawl 172 from the leg locked position (FIG. 11A) to the leg unlocked position (FIG. 11B), disengages the pawl 172 from the ratchet rack 170. Accordingly, when the pawl 172 is in the leg unlocked position, tension developed in the leg spring 148 (FIG. 10D) is released which urges the retractable leg 104 back to the leg retracted position (i.e., by returning to its natural state the leg spring 148 retracts the leg 104).

The ladder stabilizing apparatus 100 may include an anchor lock that is movable between an anchor locked position and an anchor unlocked position. In the anchor locked position, the anchor lock inhibits translation of the retractable ground anchor 106 relative to the retractable leg 104 towards the anchor retracted position. In the anchor unlocked position, translation of the retractable ground anchor 106 is uninhibited. The anchor lock does not inhibit translation of the retractable ground anchor 106 relative to the retractable leg 104 towards the ground embedded position regardless of whether the anchor lock is in the anchor locked or unlocked position. Various configurations of the anchor lock are possible. In some embodiments, the ladder stabilizing apparatus 100 may not include an anchor lock.

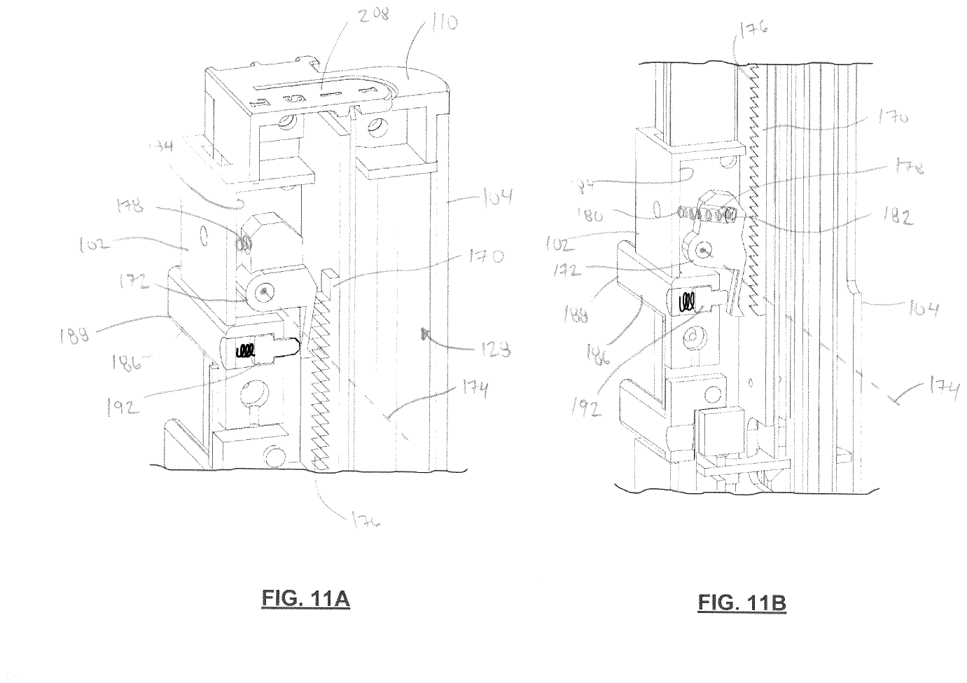

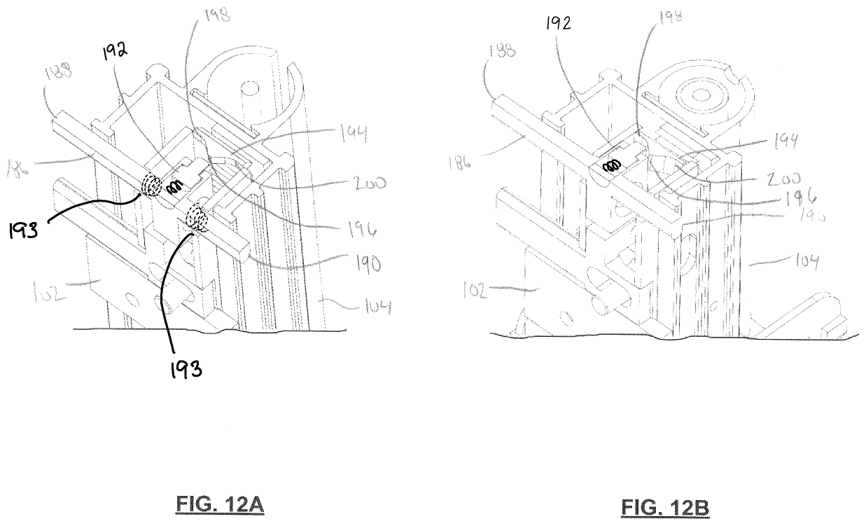

Reference is now made to FIGS. 13A-13B and FIGS. 14A-14B to demonstrate operation of the anchor lock included in the illustrated embodiment. For clarity of illustration, the anchor spring 138 and the leg spring 148 are omitted from FIG. 13B and FIGS. 14A-14B. For clarity of illustration, the leg spring 148 is omitted from FIGS. 13A-13B and FIGS. 14A-14B Referring to FIGS. 13A-13B, the anchor lock includes a locking plate 202 pivotably connected to the retractable leg 104 at a plate pivot axis 204. The locking plate 202 is pivotable about the plate pivot axis 204 between an anchor locked position (e.g., FIG. 13A) and a leg unlocked position (e.g., FIG. 13B).

The locking plate 202 includes a restriction aperture 206 formed therethrough. When in the anchor locked position, the restriction aperture 206 inhibits translation of the retractable ground anchor 106 relative to the retractable leg 104 toward the leg retracted position. When in the anchor unlocked position, the translation of the retractable ground anchor 106 relative to the retractable leg 104 is uninhibited by the restriction aperture 206. The restriction aperture 206 is dimensioned to interfere with the retractable ground anchor 106 when the locking plate 202 is in the anchor locked position. In the illustrated example, the restriction aperture 206 is dimensioned to narrowly allow unobstructed translation of the retractable ground anchor 106 therethrough when the locking plate 202 is in the anchor unlocked position (FIG. 13B). Accordingly, when the locking plate 202 is pivoted to the anchor locked position (FIG. 13A), the restriction aperture 206 interferes with the retractable ground anchor 106.

The anchor lock may be biased to the anchor locked position. The anchor lock may be biased to the anchor lock position in any suitable way. In the illustrated embodiment, the anchor lock (e.g., the locking plate 202) is biased to the anchor locked position by the anchor spring 138 (FIG. 8E). As shown in FIG. 13A, the anchor spring 138 indirectly urges the locking plate 202 upwardly at the point of the interference between the ground anchor 106 and the restriction aperture 206. This interference pivots the locking plate 202 toward the anchor locked position. In some embodiments, the anchor lock may not be biased to the anchor locked position.

In the illustrated embodiment, the ladder stabilizing apparatus 100 includes a user-operated anchor lock release actuator 208. An operator can actuate (e.g., press) the anchor lock release actuator 208 when they want to return the retractable ground anchor 106 to the anchor retracted position. Referring to FIGS. 14A-14B, the user-operated anchor lock release actuator 208 is provided in the leg upper end 110. As best illustrated in FIGS. 9A, 10A and 11A, the user-operated anchor lock release actuator 208 is formed by a “U”-shape slit 210 formed in the leg upper end 110.

With reference to FIGS. 13A and 14A, the user-operated anchor lock release actuator 208 is in a non-actuated position and the locking plate 202 is in the anchor locked position. The anchor lock release actuator 208 is connected to the locking plate 202 by a linked member 212. The linking member has a linking member first end 214 and a linking member second end 216 opposite the linking member first end 214. As shown on FIG. 13A, the linking member second end 216 is affixed to the locking plate 202. As shown on FIG. 14A, the linking member first end 214 is affixed to the anchor lock release actuator 208.

With reference to FIGS. 13B and 14B, the user-operated anchor lock release actuator 208 is in an actuated position and the locking plate 202 is in the anchor unlocked position. Comparing FIG. 14B to FIG. 14A shows that the user-operated anchor lock release actuator 208 has been depressed (i.e., pressed toward the leg lower end 112). The depression of the anchor lock release actuator 208 translates the linking member 212 downwardly, which in turns causes the locking plate 202 to pivot about the plate pivot axis 204 to the anchor unlocked position. Moving the locking plate 202 from the anchor locked position (FIG. 13A) to the anchor unlocked position (FIG. 13B), reorients the restriction aperture 206. As previously described, when the locking plate 202 is in the anchor unlocked position, translation of the ground anchor 106 is uninhibited (the restriction aperture 206 does not interfere with translation of the retractable ground anchor 106. Accordingly, when the locking plate 202 is in the anchor unlocked position, the compression developed in the anchor spring 138 is released which urges the retractable ground anchor 106 to return to the anchor retracted position (i.e., by returning to its natural state, the anchor spring 138 retracts the ground anchor 106). The upward force provided by the anchor spring 138 as it returns to its natural state may help pull the ground anchor 106 out of the ground in which it was embedded.

In the illustrated embodiment, the leg lock release actuator 186 and the anchor lock release actuator 208 are independently actuable (i.e., the user can press one and not the other). This may provide for one or more advantages. For example, an operator may actuate the anchor lock release actuator 208 to retract the ground anchor 106 without retracting the leg 104. That is, actuation of the anchor lock release actuator 208 may comprise the anchor lock (e.g., the locking plate 202) moving to the anchor unlocked position, and the leg lock (e.g., the pawl 172) remaining in the leg locked position. This may allow the operator to re-position the ladder with respect to the ground without having to adjust the position of the retractable leg 104.

Alternatively, the operator may actuate the leg lock release actuator 186 to retract the leg 104 without retracting the ground anchor 106. That is, actuation of the leg lock release actuator 186 may comprise the leg lock (e.g., the pawl 172) moving to the leg unlocked position, and the anchor lock (e.g., the locking plate 202) remaining in the anchor locked position.

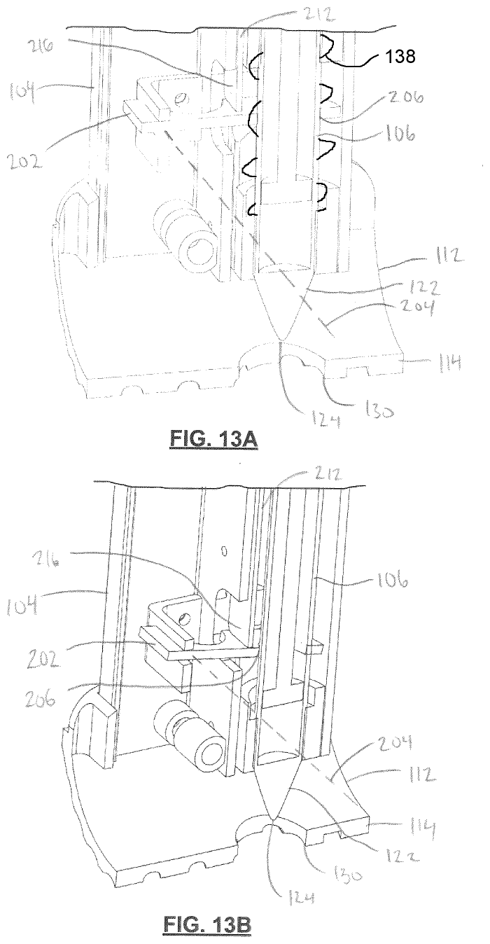

Reference is now made to FIGS. 15A-17B to illustrate a quick release mechanism of the rail mount 102. As shown on FIGS. 15A-15B, the quick release mechanism includes a ladder connector 220 attachable to a ladder side rail, a leg connector 222 rigidly attachable to the ladder connector 220, a connector lock 224, and a quick release actuator 226.

In the illustrated embodiment, the ladder connector 220 includes a pair of spaced apart male portions 228₁, 228₂ and the leg connector 222 includes a pair of spaced apart female portions 230₁, 230₂. In alternative embodiments, a different number of male and female portions 228, 230 may be provided (e.g., one of each). In alternative embodiments, the ladder connector 220 may include the one or more female portions 230 and the leg connector 222 may include the one or more male portions 228. The male portion 228 is receivable by the female portion 230 to rigidly attach the ladder connector 220 and the leg connector 222.

The male and female portions 228, 230 may have various configurations. In the illustrated embodiment, the male portion 228 includes a pair of sloped surfaces 232₁, 232₂ spaced apart by a male upper end 234 and a male lower end 236. The female portion 230 has a shape complimentary to the male portion 228. The male portion 228 may be lowered into the female portion 230. Alternatively, the female portion 230 may be raised to receive the male portion 228 therein.

The ladder connector 220 may be attached to the ladder side rail in any manner that provides a rigid connection between the ladder connector 220 and the ladder side rail. For example, the ladder connector 220 may be configured as a clamp having a pair of spaced apart fingers that are tightenable against opposite sides of the ladder side rail. In the illustrated embodiment, the ladder connector 220 includes a pair of mounting apertures 108 through which fasteners (e.g., screws, bolts, etc.) may pass to attach the ladder connector 220 to the ladder side rail.

The leg connector 222 can have various configurations and attach to the retractable leg various ways. In the illustrated example, the leg connector 222 includes a pair of sidewalls 238, 240 and an end wall 242 extending between the sidewalls 238, 240. The end wall 242 includes the female portions 230₁, 230₂. The sidewalls 238, 240 include respective apertures to allow the user-operated leg lock release actuator 186 and the quick release actuator 226 to extend therethrough. Each of the sidewalls 238, 240 of leg connector 222 slidably engage a respective one of the channel sidewalls 164, 166 of the retractable leg 104. In this arrangement, the sidewalls 238, 240 cooperate to retain the retractable leg 104 therebetween. Each of the sidewalls 238, 240 have an inwardly facing catch 244 at the distal end thereof. As shown on FIGS. 15A-15B, the inwardly facing catches 244 engages a backside surface of a respective one of channel sidewalls 164, 166. Inwardly facing catches 244 may strengthen the engagement between the leg connector 222 and the retractable leg 104. Alternatively, or in addition, the inwardly facing catches 244 may inhibit unintended disengagement of the retractable leg 104 from the leg connector 222. In alternative embodiments, the sidewalls 238, 248 of leg connector 222 may not have an inwardly facing catch 244.

The connector lock 224 is movable between a connector locked position and a connector unlocked position. The connector lock 224 is preferably biased to the connector locked position (e.g., by a spring 225—see FIG. 8E). In some embodiments, the connector lock 224 may not be biased to the connector locked position.

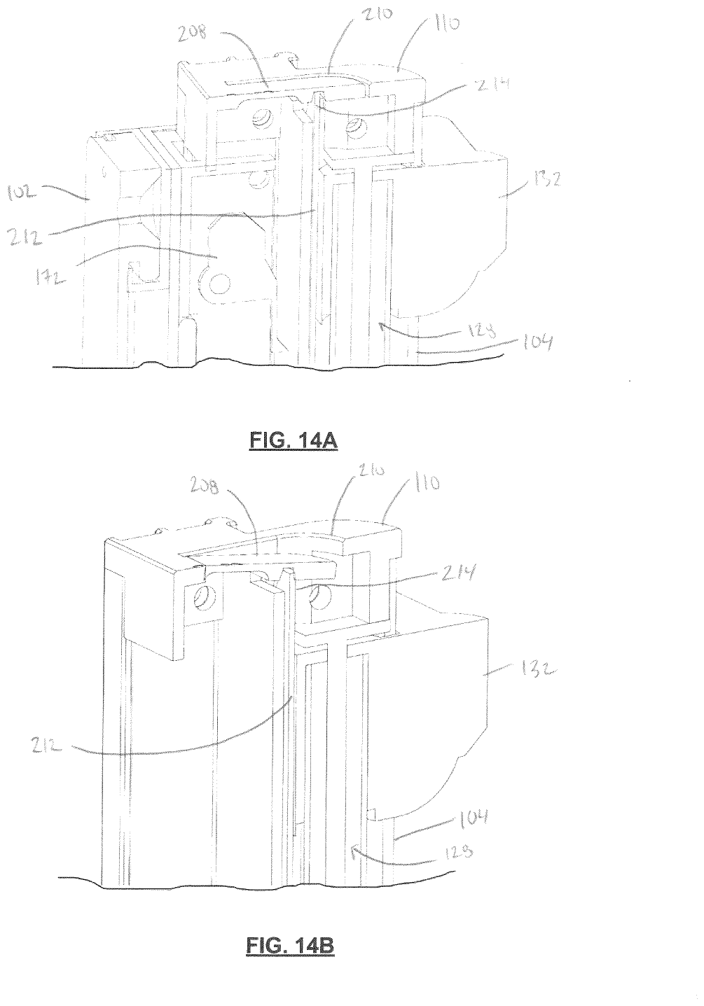

In the illustrated embodiment, the connector lock 224 is configured as a peg that slides within a lock aperture 246 formed in the leg connector 222. FIG. 16A shows the connector lock 224 in the connector locked position. When the male portion 228 is received by the female portion 230, and the connector lock 224 is in the locked position, the connector lock 224 inhibits separation of the ladder connector 220 and the leg connector 222. As shown, the connector lock 224 overlies at least a portion of the upper end 234 of the male portion 228 when in the connector locked position. Accordingly, when one attempts to separate the ladder and leg connectors 220, 222, the connector lock 224 obstructs passage of the upper end 234 of the male portion 228 in an upward direction relative to the female portion 230. The male portion 228 is therefore unable to exit the female portion 230 when the connector lock 224 is in the connector locked position.

FIG. 16B shows the connector lock 224 in the connector unlocked position. When the male portion 228 is received by the female portion 230, and the connector lock 224 is in the connector unlocked position, separation of the ladder connector 220 and the leg connector 222 is uninhibited. When one attempts to separate the ladder and leg connectors 220, 222, the connector lock 224 does not obstruct passage of the upper end 234 of the male portion 228 in an upward direction relative to the female portion 230.

Attaching the ladder connector 220 and the leg connector 222 comprises the female portion 230 receiving the male portion 228, and the connector lock 224 moving to the connector locked position (FIG. 16A). As shown on FIG. 15B, the male portion 228 includes a ramp 248 positioned to align with the connector lock 224 during attachment. As the male portion 228 is received by the female portion 230, the connector lock 224 rides up the ramp 248, which in turn causes the connector lock 224 to move inwardly (e.g., overcoming spring 225 (FIG. 8E)) toward the connector unlocked position. Once the upper end 234 of male portion 228 has passed the connector lock 224, the connector lock 224 returns to the connector locked position as it is biased to the connector locked position.

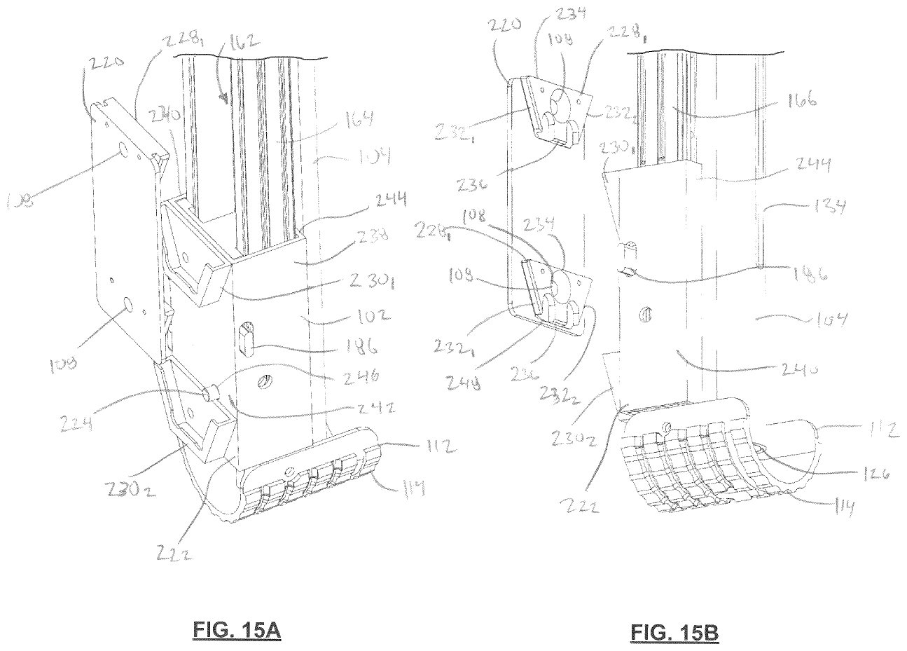

When actuated, the quick release actuator 226 moves the connector lock 224 to the connector unlocked position (FIG. 16B). An operator can actuate (e.g., press) the quick release actuator 226 when they want to separate the leg connector 222 from the ladder connector 220. Referring to FIG. 17A, the quick release actuator 226 has an end portion 250 and a ramp portion 252 spaced apart from the end portion 250. The end portion 250 of the quick release actuator 226 extends outwardly from the rail mount 102. The quick release actuator 226 is actuated by pressing the end portion 250 inwardly (towards the rail mount 102).

The ramp portion 252 of the quick release actuator 226 includes an inclined aperture 254. The connector lock 224 has a connector head 256 on the end opposite to one that passes through lock aperture 246 (FIGS. 16A-16B). As shown, the connector lock 224 passes through the inclined aperture 254 in the ramp portion 252. The connector head 256 is sized to prevent disengagement of the connector lock 224 and the ramp portion 252.

FIG. 17A shows the quick release actuator 226 in a non-actuated position. When the quick release actuator 226 is in this position, the lock connector 224 is in the connector locked position (FIG. 16A).

FIG. 17B shows the quick release actuator 226 in an actuated position. Compared to FIG. 17A, the end portion 250 has been pushed inwardly. Actuation of the quick release actuator 226 moves the ramp portion 252 in the direction of the actuation (left as viewed in FIGS. 17A-17B). As the ramp portion 252 moves, the underside surface of the connector head 256 is pulled upwardly along the inclined ramp portion 252. This has the effect of moving the connector lock 224 to the connector unlocked position exemplified in FIG. 16B. When the force applied to actuate the quick release actuator 226 is released, quick release actuator 226 returns to the non-actuated position, and connector lock 224 returns to the connector locked position (e.g., by the urging of spring 225—FIG. 8E).

FIG. 18 shows a detachable foot 114 separated from the retractable leg 104. Being able to detach the foot from the leg lower end 112 may facilitate foot replacement, foot swapping, and/or simplify maintenance. The foot 114 may be attached to the leg lower end 112 in any manner that provides a firm connection and facilitates attachment and detachment that does not damage the retractable leg 104 or the foot 114. In the illustrated embodiment, a connector pin 258 is passed through aligned apertures 260 and 262 in the foot and the lower leg end, respectively.

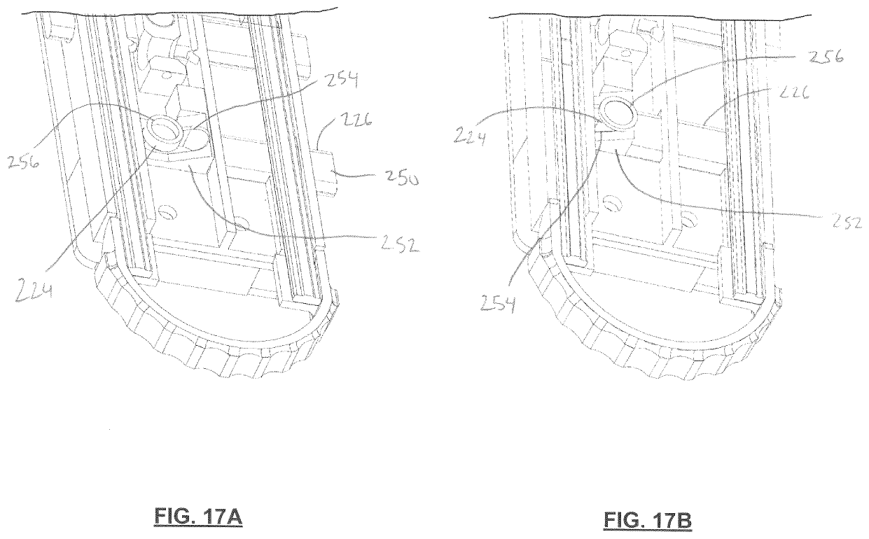

Reference is made to FIGS. 19A and 19B, which illustrate a foot adapter 264 in accordance with an embodiment. As shown, the foot adapter 264 includes a rounded slot 266 that is sized to receive the rounded ground engagement surface 116 of the foot 114 (see e.g., FIG. 18). The rounded slot 266 is bounded at least in part by an adapter upper portion 268, an adapter lower portion 270, and an adapter end portion 272 that joins the adapter upper and lower portions 268, 270. Once the slot 266 of the foot adapter 264 has received the ground engagement surface 116 of the foot 114, a locking pin 274 may be used to secure the engagement. As shown on FIG. 19B, the locking pin 274 can be passed through apertures in the adapter upper and lower portions 268, 270 to inhibit disengagement of the ground engagement surface 116 from the slot 266. In some embodiments, the ladder stabilizing apparatus 100 may not include a foot adapter 264.

The foot adapter 264 has a flat ground engagement surface 276 that includes a plurality of spikes 278. Accordingly, attaching the foot adapter 264 to the foot 114 provides a flat ground engagement surface 276 (as opposed to the rounded ground engagement surface 116 of the foot 114). The flat ground engagement surface 276 may be beneficial for use on level ground. Alternatively, or in addition, the foot adapter 264 can be attached to inhibit translation of the retractable ground anchor 106 toward the ground embedded position (there is no opening in the foot adapter 264 for the ground anchor 106 to pass through). The foot adapter 264 may be attached to the foot 114 when the ladder is used indoors (e.g., when the operator does not want deployment of the ground anchor to damage their floor). The foot adapter 264 may also be attached to the foot 114 for applications in which embedding the retractable ground anchor 106 in the ground is not possible (e.g., concrete). In some embodiments, the flat ground engagement surface 276 may not include spikes 278.

FIG. 20 shows a schematic illustration of a kit 300 in accordance with an embodiment. As shown, the kit 300 includes the ladder stabilizing apparatus 100 and a plurality of detachable feet 114₁, 114₂, and 114₃ (e.g., at least two feet, such as three feet as shown, or four or more feet). Each of the feet 114 is selectively separately attachable to the leg lower end 112. An operator may select which one of the feet 114 (if any) to attach to the leg lower end 112 based on the type of ground beneath the ladder (e.g., grass, dirt, hardwood flooring, gravel, concrete, etc.)

In the illustrated example, detachable feet 114₁ and 114₂ include an anchor opening 130. When one of foot 114₁ and foot 114₂ is attached to the leg lower end 112, the anchor opening 130 of the foot 114 aligns with the anchor opening 126 of the retractable leg 104. As shown on FIG. 10E, the retractable ground anchor 106 can pass through the aligned anchor openings 126, 130 without obstruction. Accordingly, with either of foot 114₁ or 114₂ attached, downward actuation of the foot pedal 132 comprises the retractable leg 104 translating relative to the rail mount 102 towards the foot planted position, and the retractable ground anchor 106 translating through the anchor opening 130 towards the ground embedded position.

Feet 114₁ and 114₂ differ in that the rounded ground engagement surface 116 of foot 114₂ includes a plurality of spikes 280. The spikes 280 can dig into the ground, and thereby improve engagement between the foot 114₂ and the ground. In use, the spikes 280 can reduce the likelihood of retractable leg 104 slipping relative to the ground compared with a foot 114 without spikes 280. Foot 114₂ may be particularly beneficial when the ladder is supported on soft ground.

Foot 114₃ does not have an anchor opening like feet 114₁, 114₂. When the foot 114₃ is attached to the leg lower end 112, the foot 114₃ inhibits translation of the retractable ground anchor 106 toward the ground embedded position (i.e., there is no opening for the ground anchor 106 to pass through). Therefore, with foot 114₃ attached, downward actuation of the foot pedal 132 comprises the retractable leg 104 translating relative to the rail mount 102 towards the foot planted position, and the foot 114₃ inhibiting translation of the retractable ground anchor 106 towards the ground embedded position. Foot 114₃ may be particularly suited for indoor use in which deployment of the ground anchor 106 may damage the floor. Foot 114₃ may also be attached to the leg lower end 112 for applications in which embedding the retractable ground anchor 106 in the ground is impractical (e.g., concrete).

In some embodiments, the kit 300 includes more than three detachable feet 114 (e.g., 4-10). In other embodiments, the kit 300 includes less than three detachable feet 114 (e.g., 1 or 2). In some embodiments, the kit includes a plurality of ladder stabilizing apparatuses 100 (e.g., 2, 3, 4, etc.). For example, the kit 300 may include two ladder stabilizing apparatuses 100, two detachable feet 114₁, two detachable feet 114₂ and two detachable feet 114₃. Any one or more (or all) of the detachable feet 114 may include an anchor opening. Similarly, any one or more or all of the detachable feet 114 may not include an anchor opening.

In some embodiments, the kit 300 includes one or more of the foot adapters 264 of FIGS. 19A-19B. Attaching the foot adapter 264 to any one of the feet 114₁, 114₂, 114₃ provides a flat ground engagement surface 276 (as opposed to the rounded ground engagement surface 116 of the feet 114₁, 114₂, 114₃). As previously discussed, the foot adapter 264 can be attached to inhibit translation of the retractable ground anchor 106 toward the ground embedded position (there is no opening in the foot adapter 264 for the ground anchor 106 to pass through). Alternatively, or in addition, the flat ground engagement surface 276 of the foot adapter 264 may be beneficial for use on level ground. The foot adapter 264 may be attached to any one of the feet 114₁, 114₂, 114₃ when the ladder is used indoors (e.g., the operator does not want deployment of the ground anchor to damage their floor). The foot adapter 264 may also be attached to any one of the feet 114₁, 114₂, 114₃ for applications in which embedding the retractable ground anchor 106 in the ground is not possible (e.g., concrete).

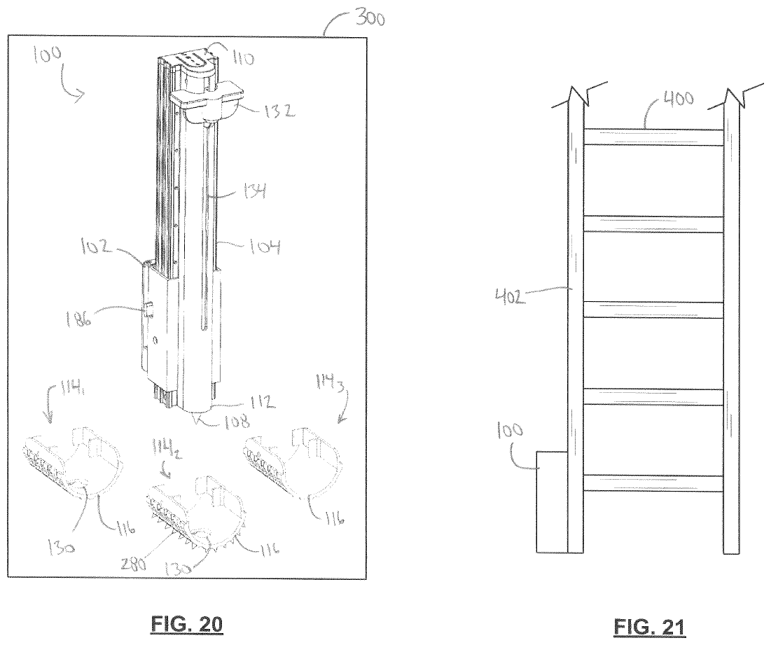

FIG. 21 shows a schematic illustration of a ladder 400 having a ladder stabilizing apparatus 100 connected to ladder side rail 402. The ladder stabilizing apparatus 100 of ladder 400 may be any one of the embodiments of the apparatus 100 described herein.

While the above description provides examples of one or more apparatuses or methods, it will be appreciated that other apparatuses or methods may be within the scope of the accompanying claims.

### ITEMS

Item 1. A ladder stabilizing apparatus comprising:
   a rail mount attachable to a ladder side rail;
   a retractable leg translatably coupled to the rail mount and translatable relative to the rail mount between a leg retracted position and a foot planted position, the retractable leg extending between a leg upper end and a leg lower foot;
   a leg lock movable between a leg locked position, in which the leg lock inhibits a translation of the retractable leg relative to the rail mount towards the leg retracted position, and a leg unlocked position in which the translation of the retractable leg is uninhibited;
   a retractable ground anchor translatably coupled to the retractable leg and translatable relative to the retractable leg between an anchor retracted position and a ground embedded position, the retractable ground anchor extending between an anchor upper end and a lower ground piercing end;
   an anchor lock movable between an anchor locked position, in which the anchor lock inhibits a translation of the retractable ground anchor relative to the retractable leg toward the anchor retracted position, and an anchor unlocked position, in which the translation of the retractable ground anchor is uninhibited; and
   a foot pedal downwardly actuatable from a raised position to a depressed position, wherein downward actuation of the foot pedal comprises the retractable leg translating relative to the rail mount towards the foot planted position, and the retractable ground anchor translating relative to the retractable leg towards the ground embedded position.
Item 2. The ladder stabilizing apparatus of any preceding item:
   wherein the downward actuation of the foot pedal comprises a first movement stage in which the retractable leg moves towards the foot planted position, and a second movement stage in which the retractable ground anchor moves towards the ground embedded position and the retractable leg is stationary.
Item 3. The ladder stabilizing apparatus of any preceding item:
   wherein the retractable leg is biased to the leg retracted position, and the retractable ground anchor is biased to the anchor retracted position.
Item 4. The ladder stabilizing apparatus of any preceding item:
   wherein the leg lock is biased to the leg locked position, and the anchor lock is biased to the anchor locked position.
Item 5. The ladder stabilizing apparatus of any preceding item:
   further comprising a user-operated anchor lock release actuator that when actuated moves the anchor lock to the anchor unlocked position.
Item 6. The ladder stabilizing apparatus of any preceding item:
   wherein actuation of the anchor lock release actuator comprises the anchor lock moving to the anchor unlocked position, and the leg lock remaining in the leg locked position.
Item 7. The ladder stabilizing apparatus of any preceding item:
   further comprising a user-operated leg lock release actuator that when actuated moves the leg lock to the leg unlocked position.
Item 8. The ladder stabilizing apparatus of any preceding item:
   wherein actuation of the leg lock release actuator comprises the leg lock moving to the leg unlocked position, and the anchor lock remaining in the anchor locked position.
Item 9. The ladder stabilizing apparatus of any preceding item:
   wherein the lower ground piercing end is level with or retracted above the leg lower foot when the retractable ground anchor is in the anchor retracted position.
Item 10. The ladder stabilizing apparatus of any preceding item:
   wherein the retractable leg includes an anchor opening and an internal passage extending upwardly from the anchor opening, the retractable ground anchor being translatable within the internal passage of the retractable leg.
Item 11. The ladder stabilizing apparatus of any preceding item:
   wherein the leg lower foot has a rounded ground engagement surface.
Item 12. A ladder comprising the ladder side rail and the ladder stabilizing apparatus of any preceding item.
Item 13. A ladder stabilizer apparatus comprising:
   a rail mount having a quick release mechanism, the quick release mechanism comprising:
      a ladder connector attachable to a ladder side rail; and
      a leg connector rigidly attachable to the ladder connector, wherein one of the ladder connector and the leg connector includes a male portion and the other of the ladder connector and the leg connector includes a female portion, the male portion receivable by the female portion to rigidly attach the ladder connector and the leg connector;
      a connector lock movable between a connector locked position and a connector unlocked position, the connector lock being biased to the connector locked position, wherein attaching the ladder connector and the leg connector comprises the female portion receiving the male portion, and the connector lock moving to the connector locked position, and
         when the male portion is received by the female portion, and the connector lock is in the connector locked position, the connector lock inhibits separation of the ladder connector and the leg connector, and
         when the male portion is received by the female portion, and the connector lock is in the connector unlocked position, separation of the ladder connector and the leg connector is uninhibited; and
      a quick release actuator that when actuated moves the connector lock to the connector unlocked position; and
   a retractable leg translatably coupled to the leg connector and translatable relative to the leg connector between a leg retracted position and a foot planted position, the retractable leg extending between a leg upper end and a leg lower foot.
Item 14. The ladder stabilizer apparatus of any preceding item:
   further comprising a leg lock movable between a leg locked position, in which the leg lock inhibits a translation of the retractable leg relative to the rail mount towards the leg retracted position, and a leg unlocked position in which the translation of the retractable leg is uninhibited.
Item 15. The ladder stabilizing apparatus of any preceding item:
   further comprising a user-operated leg lock release actuator that when actuated moves the leg lock to the leg unlocked position.
Item 16. The ladder stabilizing apparatus of any preceding item:
   wherein the retractable leg is biased to the leg retracted position, and the leg lock is biased to the leg locked position.
Item 17. The ladder stabilizer apparatus of any preceding item,
   further comprising a foot pedal that when actuated downwardly translates the retractable leg relative to the rail mount towards the foot planted position.
Item 18. A kit comprising:
   I) a ladder stabilizing apparatus comprising:
      a rail mount attachable to a ladder side rail;
      a retractable leg translatably coupled to the rail mount and translatable relative to the rail mount between a leg retracted position and a foot planted position, the retractable leg extending between a leg upper end and a leg lower end;
      a leg lock movable between a leg locked position, in which the leg lock inhibits a translation of the retractable leg relative to the rail mount towards the leg retracted position, and a leg unlocked position in which the translation of the retractable leg is uninhibited;
      a retractable ground anchor translatably coupled to the retractable leg and translatable relative to the retractable between an anchor retracted position and a ground embedded position, the retractable ground anchor extending between an anchor upper end and a lower ground piercing end;
      an anchor lock movable between an anchor locked position in which the anchor lock inhibits a translation of the retractable ground anchor relative to the retractable leg toward the anchor retracted position, and an anchor unlocked position in which the translation of the retractable ground anchor is uninhibited; and
      a foot pedal downwardly actuatable from a raised position to a depressed position to translate at least one of the retractable leg and the retractable ground anchor;
   II) a plurality of detachable feet including at least a first foot and a second foot, each of the detachable feet being separately attachable to the leg lower end, the first foot including an anchor opening,
   wherein, when the first foot is attached to the leg lower end, downward actuation of the foot pedal comprises the retractable leg translating relative to the rail mount towards the foot planted position, and the retractable ground anchor translating through the anchor opening towards the ground embedded position, and
   wherein, when the second foot is attached to the leg lower end, downward actuation of the foot pedal comprises the retractable leg translating relative to the rail mount towards the foot planted position, and the second foot inhibiting translation of the retractable ground anchor towards the ground embedded position.
Item 19. The kit of any preceding item:
   wherein the retractable leg includes an anchor opening and an internal passage extending upwardly from the anchor opening, the retractable ground anchor translatable within the internal passage of the retractable leg.
Item 20. The kit of any preceding item:
   wherein, when the first foot is attached to the leg lower end, the anchor opening of the retractable leg and the anchor opening of the first foot are aligned.

1. A ladder stabilizing apparatus comprising:
a rail mount attachable to a ladder side rail;
a retractable leg translatably coupled to the rail mount and translatable relative to the rail mount between a leg retracted position and a foot planted position, the retractable leg extending between a leg upper end and a leg lower foot;
a leg lock movable between a leg locked position, in which the leg lock inhibits a translation of the retractable leg relative to the rail mount towards the leg retracted position, and a leg unlocked position in which the translation of the retractable leg is uninhibited;
a retractable ground anchor translatably coupled to the retractable leg and translatable relative the retractable leg between an anchor retracted position and a ground embedded position, the retractable ground anchor extending between an anchor upper end and a lower ground piercing end;
an anchor lock movable between an anchor locked position, in which the anchor lock inhibits a translation of the retractable ground anchor relative to the retractable leg toward the anchor retracted position, and an anchor unlocked position, in which the translation of the retractable ground anchor is uninhibited; and
a foot pedal downwardly actuatable from a raised position to a depressed position, wherein downward actuation of the foot pedal comprises the retractable leg translating relative to the rail mount towards the foot planted position, and the retractable ground anchor translating relative to the retractable leg towards the ground embedded position.

2. The ladder stabilizing apparatus of claim 1, wherein the downward actuation of the foot pedal comprises a first movement stage in which the retractable leg moves towards the foot planted position, and a second movement stage in which the retractable ground anchor moves towards the ground embedded position and the retractable leg is stationary.

3. The ladder stabilizing apparatus of claim 1 or 2, wherein the retractable leg is biased to the leg retracted position, and the retractable ground anchor is biased to the anchor retracted position.

4. The ladder stabilizing apparatus of any one of claims 1-3, wherein the leg lock is biased to the leg locked position, and the anchor lock is biased to the anchor locked position.

5. The ladder stabilizing apparatus of claim 4, further comprising a user-operated anchor lock release actuator that when actuated moves the anchor lock to the anchor unlocked position.

6. The ladder stabilizing apparatus of claim 5, wherein actuation of the anchor lock release actuator comprises the anchor lock moving to the anchor unlocked position, and the leg lock remaining in the leg locked position.

7. The ladder stabilizing apparatus of any one of claims 4-6, further comprising a user-operated leg lock release actuator that when actuated moves the leg lock to the leg unlocked position.

8. The ladder stabilizing apparatus of claim 7, wherein actuation of the leg lock release actuator comprises the leg lock moving to the leg unlocked position, and the anchor lock remaining in the anchor locked position.

9. The ladder stabilizing apparatus of any one of claim 1-8, wherein the lower ground piercing end is level with or retracted above the leg lower foot when the retractable ground anchor is in the anchor retracted position.

10. The ladder stabilizing apparatus of any one of claims 1-9, wherein the retractable leg includes an anchor opening and an internal passage extending upwardly from the anchor opening, the retractable ground anchor being translatable within the internal passage of the retractable leg.

11. The ladder stabilizing apparatus of any one of claims 1-10, wherein the leg lower foot has a rounded ground engagement surface.

12. A ladder comprising the ladder side rail and the ladder stabilizing apparatus of any one of claims 1-11.

13. A ladder stabilizer apparatus comprising:
a rail mount having a quick release mechanism, the quick release mechanism comprising:
a ladder connector attachable to a ladder side rail; and
a leg connector rigidly attachable to the ladder connector, wherein one of the ladder connector and the leg connector includes a male portion and the other of the ladder connector and the leg connector includes a female portion, the male portion receivable by the female portion to rigidly attach the ladder connector and the leg connector;
a connector lock movable between a connector locked position and a connector unlocked position, the connector lock being biased to the connector locked position, wherein attaching the ladder connector and the leg connector comprises the female portion receiving the male portion, and the connector lock moving to the connector locked position, and
when the male portion is received by the female portion, and the connector lock is in the connector locked position, the connector lock inhibits separation of the ladder connector and the leg connector, and
when the male portion is received by the female portion, and the connector lock is in the connector unlocked position, separation of the ladder connector and the leg connector is uninhibited; and
a quick release actuator that when actuated moves the connector lock to the connector unlocked position; and
a retractable leg translatably coupled to the leg connector and translatable relative to the leg connector between a leg retracted position and a foot planted position, the retractable leg extending between a leg upper end and a leg lower foot.

14. The ladder stabilizer apparatus of claim 13, further comprising a leg lock movable between a leg locked position, in which the leg lock inhibits a translation of the retractable leg relative to the rail mount towards the leg retracted position, and a leg unlocked position in which the translation of the retractable leg is uninhibited.

15. The ladder stabilizing apparatus of claim 14, further comprising a user-operated leg lock release actuator that when actuated moves the leg lock to the leg unlocked position.

16. The ladder stabilizing apparatus of claim 14 or 15, wherein the retractable leg is biased to the leg retracted position, and the leg lock is biased to the leg locked position.

17. The ladder stabilizer apparatus of any one of claims 13-16, further comprising a foot pedal that when actuated downwardly translates the retractable leg relative to the rail mount towards the foot planted position.

18. A kit comprising:
I) a ladder stabilizing apparatus comprising:
a rail mount attachable to a ladder side rail;
a retractable leg translatably coupled to the rail mount and translatable relative to the rail mount between a leg retracted position and a foot planted position, the retractable leg extending between a leg upper end and a leg lower end;
a leg lock movable between a leg locked position, in which the leg lock inhibits a translation of the retractable leg relative to the rail mount towards the leg retracted position, and a leg unlocked position in which the translation of the retractable leg is uninhibited;
a retractable ground anchor translatably coupled to the retractable leg and translatable relative the retractable leg between an anchor retracted position and a ground embedded position, the retractable ground anchor extending between an anchor upper end and a lower ground piercing end;
an anchor lock movable between an anchor locked position in which the anchor lock inhibits a translation of the retractable ground anchor relative to the retractable leg toward the anchor retracted position, and an anchor unlocked position in which the translation of the retractable ground anchor is uninhibited; and
a foot pedal downwardly actuatable from a raised position to a depressed position to translate at least one of the retractable leg and the retractable ground anchor;
II) a plurality of detachable feet including at least a first foot and a second foot, each of the detachable feet being separately attachable to the leg lower end, the first foot including an anchor opening,
wherein, when the first foot is attached to the leg lower end, downward actuation of the foot pedal comprises the retractable leg translating relative to the rail mount towards the foot planted position, and the retractable ground anchor translating through the anchor opening towards the ground embedded position, and
wherein, when the second foot is attached to the leg lower end, downward actuation of the foot pedal comprises the retractable leg translating relative to the rail mount towards the foot planted position, and the second foot inhibiting translation of the retractable ground anchor towards the ground embedded position.

19. The kit of claim 18, wherein the retractable leg includes an anchor opening and an internal passage extending upwardly from the anchor opening, the retractable ground anchor translatable within the internal passage of the retractable leg.

20. The kit of claim 19, wherein, when the first foot is attached to the leg lower end, the anchor opening of the retractable leg and the anchor opening of the first foot are aligned.
